(19) United States
(12) Patent Application Publication
(10) Pub. No.: US 2019/0116359 A1
(43) Pub. Date: Apr. 18, 2019

(54) GUIDED FILTER FOR VIDEO CODING AND PROCESSING

(71) Applicant: QUALCOMM Incorporated, San Diego, CA (US)

(72) Inventors: Jie Dong, Sunnyvale, CA (US); Jianle Chen, San Diego, CA (US); Marta Karczewicz, San Diego, CA (US)

(21) Appl. No.: 16/158,031

(22) Filed: Oct. 11, 2018

Related U.S. Application Data
(60) Provisional application No. 62/571,563, filed on Oct. 12, 2017.

(51) Int. Cl. H04N 19/117; H04N 19/82; H04N 19/105; H04N 19/172

(52) U.S. Cl. CPC H04N 19/117; H04N 19/172; H04N 19/105; H04N 19/82

(57) ABSTRACT

A video decoder can be configured to determine a reconstructed image; apply a first filter to the reconstructed image to determine a first filtered image; based on the reconstructed image, determine parameters for a second filter; apply the second filter, using the parameters for the second filter, to the first filtered image to determine a second filtered image.

This application claims the benefit of U.S. Provisional Application No. 62/571,563, filed 12 Oct. 2017, which is hereby incorporated by reference in its entirety.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

This disclosure describes techniques associated with filtering reconstructed video data in a video encoding and/or video decoding process and, more particularly, this disclosure describes techniques related to a guided filter (GF), which is a filtering process that may be performed on video frames distorted by compression, blurring, or other effects. A guided filter may improve the objective and subjective qualities of the video frames.

According to one example, a method of decoding video data includes determining a reconstructed image; applying a first filter to the reconstructed image to determine a first filtered image; based on the reconstructed image, determining parameters for a second filter; applying the second filter, using the parameters for the second filter, to the first filtered image to determine a second filtered image.

According to another example, a device for decoding video data includes a memory configured to store the video data and one or more processors coupled to the memory, implemented in circuitry, and configured to determine a reconstructed image; apply a first filter to the reconstructed image to determine a first filtered image; based on the reconstructed image, determine parameters for a second filter; and apply the second filter, using the parameters for the second filter, to the first filtered image to determine a second filtered image.

According to another example, a computer readable storage medium stores instructions that when executed by one or more processors cause the one or more processors to determine a reconstructed image; apply a first filter to the reconstructed image to determine a first filtered image; based on the reconstructed image, determine parameters for a second filter; apply the second filter, using the parameters for the second filter, to the first filtered image to determine a second filtered image.

According to another example, an apparatus for decoding video data includes means for determining a reconstructed image; means for applying a first filter to the reconstructed image to determine a first filtered image; means for determining parameters for a second filter based on the reconstructed image; means for applying the second filter, using the parameters for the second filter, to the first filtered image to determine a second filtered image.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIG. 3 shows a diagram of a guided filter process unit.

FIGS. 4A-4D illustrate techniques for aᵢ and bᵢ (r=1) in a guided filter process.

FIG. 5 is a conceptual diagram illustrating categories for adaptive loop filtering.

FIG. 6 is a conceptual diagram illustrating pixels classified into 25 categories that share filters after category merge.

FIG. 7 is a conceptual diagram illustrating example of signaling how filters are shared after category merge (for N=5).

FIG. 8 shows example quantization levels for filter coefficients.

FIG. 9 is a flowchart illustrating the in-loop filtering stage in a video coding framework.

FIGS. 10A-10E show example arrangements for filter units for performing in-loop filtering.

FIG. 11 shows a diagram of a guided filter process unit.

FIG. 12 shows an example of frame boundary extension.

FIG. 13 shows an example of support region reduction for boundary pixels.

FIG. 14 shows examples of epsIndTab storing ε indices for each category and how to code epsIndTab.

FIG. 15 shows an example implementation of a filter unit for performing in-loop filtering with GF.

FIG. 16 shows an example encoder-side optimization of the proposed GF filtering process with ALF as the “I Generator.”

FIG. 17 shows an example implementation of a filter unit that include concatenating ALF and GF.

FIG. 18 shows an example implementation of a filter unit that includes N in-loop filters concatenated with short latency.

FIG. 19 is a block diagram illustrating an example video encoder that may perform the techniques of this disclosure.

FIG. 20 is a block diagram illustrating an example video decoder that may perform the techniques of this disclosure.

FIG. 21 is a flowchart illustrating an example operation of a video encoder.

FIG. 22 is a flowchart illustrating an example operation of a video decoder.

FIG. 23 is a flowchart illustrating an example operation of a video decoder.

### DETAILED DESCRIPTION

Video coding (e.g., video encoding and/or video decoding) typically involves predicting a block of video data from either an already coded block of video data in the same picture (i.e. intra prediction) or an already coded block of video data in a different picture (i.e. inter prediction). In some instances, the video encoder also calculates residual data by comparing the predictive block to the original block. Thus, the residual data represents a difference between the predictive block and the original block. The video encoder transforms and quantizes the residual data and signals the transformed and quantized residual data in the encoded bitstream. A video decoder adds the residual data to the predictive block to produce a reconstructed video block that matches the original video block more closely than the predictive block alone. To further improve the quality of decoded video, a video decoder can perform one or more filtering operations on the reconstructed video blocks. Examples of these filtering operations include deblock filtering, sample adaptive offset (SAO) filtering, and adaptive loop filtering (ALF). Parameters for these filtering operations may either be determined by a video encoder and explicitly signaled in the encoded video bitstream or may be implicitly determined by a video decoder without needing the parameters to be explicitly signaled in the encoded video bitstream.

This disclosure describes techniques associated with filtering reconstructed video data in a video encoding and/or video decoding process and, more particularly, this disclosure describes techniques related to a guided filter (GF), which is a filtering process that may be performed on video frames distorted by compression, blurring, or other effects. A guided filter may improve the objective and subjective qualities of the video frames. The guided filtering techniques of this disclosure may be applied to any of the existing video codecs, such as High Efficiency Video Coding (HEVC), or may be a promising coding tool for future video coding standards, including the Versatile Video Coding (VVC) standard presently under development. The guided filtering techniques of this disclosure may also be used for post-processing of video frames output from either standard or proprietary codecs.

Although guided filtering was first proposed for video coding and processing, guided filtering, including the techniques of this disclosure, do not rely on information from previous or future video frames or on motion information in a video sequence. Therefore, the filtering techniques of this disclosure may also be applicable to image coding and processing.

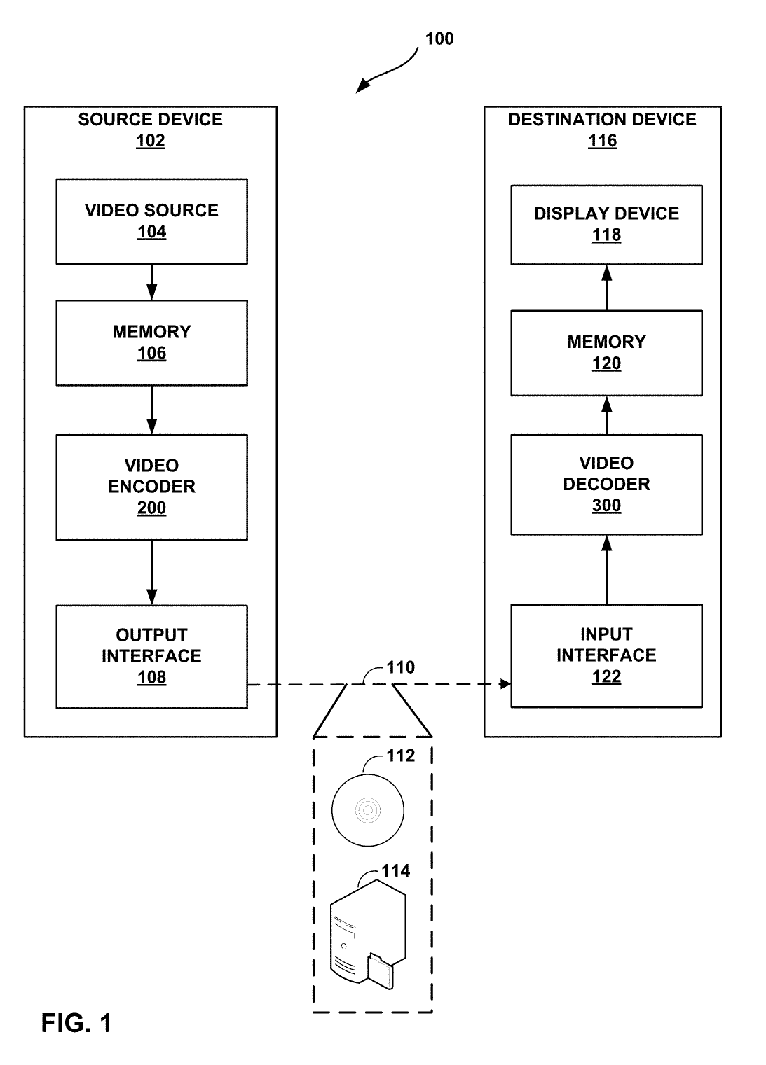

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the filtering techniques described in this disclosure. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 1 is merely one example. In general, any digital video encoding and/or decoding device may perform techniques for guided filtering. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between video devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may include one or both of a wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 116. Similarly, destination device 116 may access encoded data from storage device 116 via input interface 122. Storage device 116 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may include an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as the Joint Exploration Test Model (JEM). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to JEM. According to JEM, a video coder (such as video encoder 200) partitions a picture into a plurality of CTUs. Video encoder 200 may partition a CTU according to a tree structure, such as a quadtree-binary tree (QTBT) structure. The QTBT structure of JEM removes the concepts of multiple partition types, such as the separation between CUs, PUs, and TUs of HEVC. A QTBT structure of JEM includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In some examples, video encoder 200 and video decoder 300 may use a single QTBT structure to represent each of the luminance and chrominance components, while in other examples, video encoder 200 and video decoder 300 may use two or more QTBT structures, such as one QTBT structure for the luminance component and another QTBT structure for both chrominance components (or two QTBT structures for respective chrominance components).

Video encoder 200 and video decoder 300 may be configured to use quadtree partitioning per HEVC, QTBT partitioning according to JEM, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

JEM also provides an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. JEM provides sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

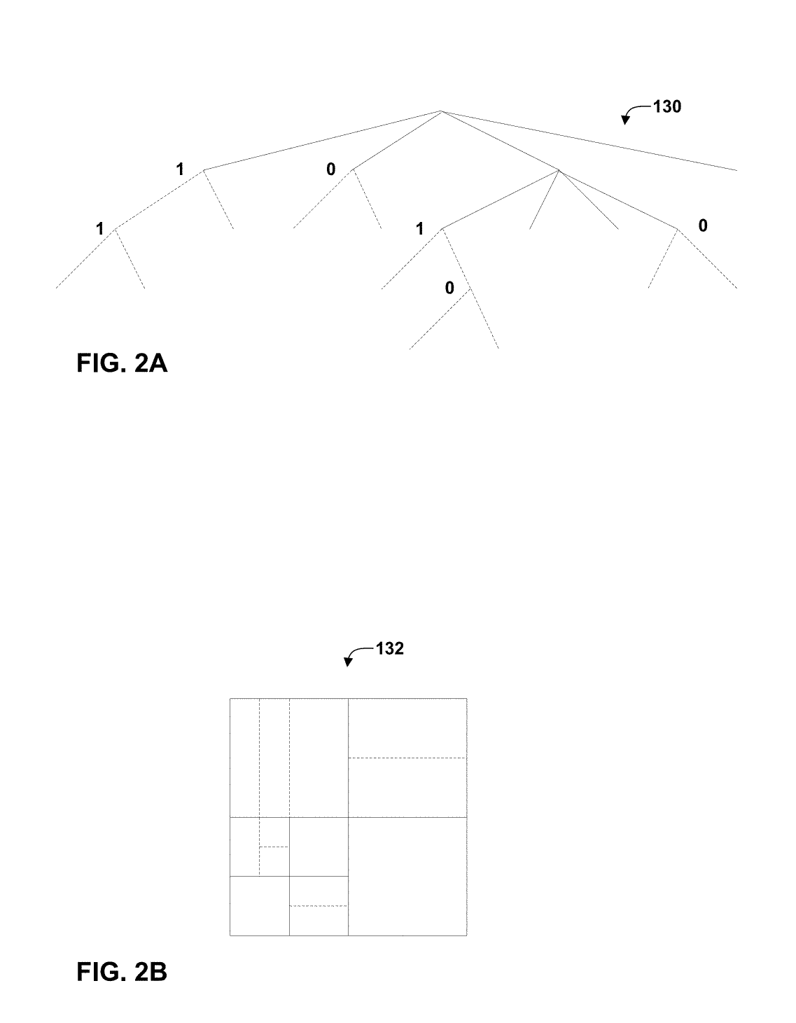

FIGS. 2A and 2B are conceptual diagram illustrating an example QTBT structure 130, and a corresponding CTU 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, since quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), they can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, then the node is not be further split by the binary tree, because the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. A binary tree node having width equal to MinBTSize (4, in this example) implies no further horizontal splitting is permitted. Similarly, a binary tree node having a height equal to MinBTSize implies no further vertical splitting is permitted for that binary tree node. As noted above, leaf nodes of the binary tree are referred to as CUs and are further processed according to prediction and transform without further partitioning.

Video encoder 200 and video decoder 300 may be configured to perform guided filtering. The techniques for guided filtering described herein may be used in place of ALF and/or SAO or may be used to compliment ALF and/or SAO. An overview of guided filtering will now be provided. A GF can be considered to be an edge-preserving smoothing operator. By using desirable values for the GF's two parameters (ε and r), the GF may work effectively for a variety of computer vision applications, such as HDR compression, flash/no-flash denoising, feathering/matting, and haze removal. It was first published in 2010 (see K. He, J. Sun, X. Tang, “Guided image filtering,” 2010 European Conference on Computer Vision, Sep. 5-11, 2010 (hereinafter “He 2010”)) and has been widely known and used nowadays.

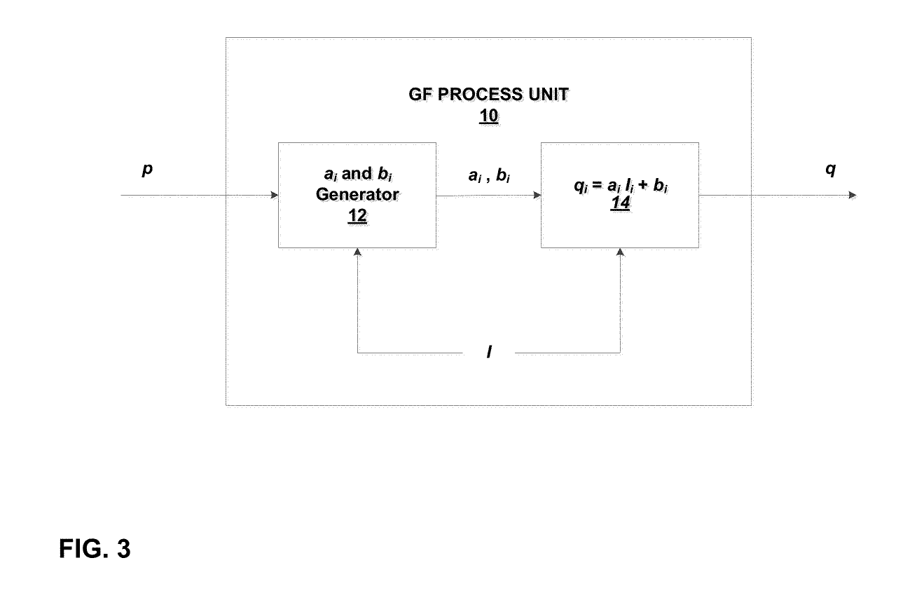

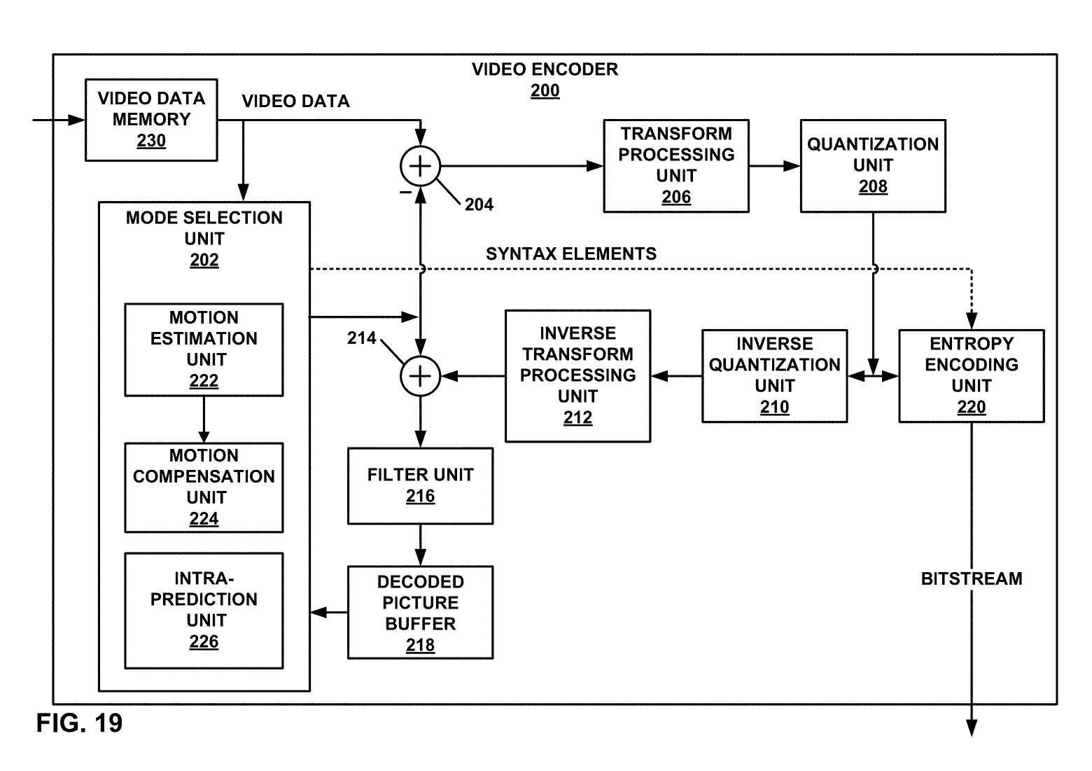

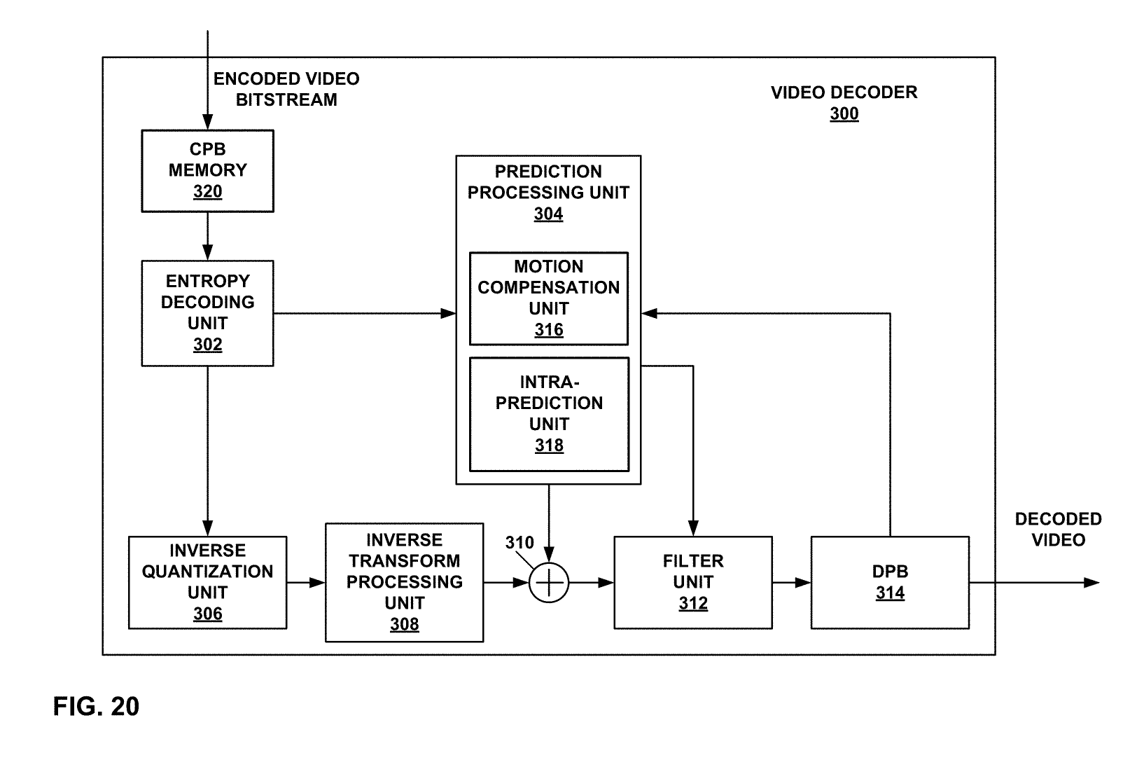

FIG. 3 shows a diagram of GF process unit 10. GF process unit 10 may, for example, be a component of video encoder 200 or video decoder 300. In some examples, GF processing unit 10 may be sub-component of filter unit 216 or filter unit 312, which are described in more detail with respect to FIGS. 19 and 20, respectively. GF process unit 10 includes ai and bi generator 12 and qᵢ determining unit 14. In the example of FIG. 3, ai and bi generator 12 receives a guidance image I and an input image p and, based on I and p, determines parameters aᵢ and bᵢ and outputs those parameters to qi determinization unit 14. Based on the parameters ai and bi, qᵢ determination unit determines output image q. In the example of FIG. 3, qi represents a filtered pixel, I, as guidance, is supposed to have higher quality than p, such as higher PSNR, better edge structure, richer details, and less noise. However, I and p can be identical, which means p guides itself in the filtering process and is a so called self-guided filtering. I, p, and q may have the same width and height in terms of pixels.

For each pixel i, ai and bi generator 12 generates its corresponding parameters ai and bi, and then ai and bi are applied to pixel Ii in the guidance image, as in (1), to obtain the output pixel qi.

qᵢ=aᵢIᵢ+bᵢ (1)

Before using I and p to jointly generate a and a neighborhood of i, i.e., a square window centered at i, should be pre-determined, of which the size is defined by radius r (e.g., r is equal to 1, 2, and 3 for 3×3, 5×5, and 7×7 windows, respectively). In addition, another parameter ε should also be pre-determined, which means how heavily the smoothing process will be performed. The larger the value is, the more heavily the smoothing is. For example, with a small ε, the smoothing is performed only on flat patches and delicate edges, and most of the edges and textures will be preserved; whereas with a large E, only strong edges can survive the smoothing. With I, p, r, and ε, aᵢ and bᵢ are calculated as in (2) and (3), respectively,

$$\begin{matrix}{a}_{i} = \frac{1}{{( 2 r + 1 )}^{2}} {\sum }_{j ∈ {w}_{i}} {a}_{j} & ( 2 ) \\ {b}_{i} = \frac{1}{{( 2 r + 1 )}^{2}} {\sum }_{j ∈ {w}_{i}} {b}_{j} & ( 3 )\end{matrix}$$

where wᵢ means the window centered at pixel i, and aⱼ and bⱼ are the intermediate values at position j in wᵢ. So aᵢ and bᵢ are the averages of all the aⱼ and bⱼ in wᵢ, respectively, and aⱼ and bⱼ are calculated as in (4) and (5), respectively,

$$\begin{matrix}{a}_{j} = \frac{\frac{1}{{( 2 r + 1 )}^{2}} {\sum }_{n ∈ {w}_{j}} {I}_{n} {p}_{n} - {μ}_{j} {\overline{p}}_{j}}{{σ}_{j}^{2} + ɛ} & ( 4 ) \\ {b}_{j} = {\overline{p}}_{j} - {a}_{j} {μ}_{j} & ( 5 )\end{matrix}$$

where wⱼ is the same-size window centered at position j, μⱼ and σⱼ² are the mean and variance of I in wⱼ, and p̅ⱼ is the mean of p in wⱼ.

In the case of self-guided filtering, i.e., p and I are identical, (4) and (5) can be re-written as in (6) and (7), respectively.

$$\begin{matrix}{a}_{j} = \frac{{σ}_{j}^{2}}{{σ}_{j}^{2} + ɛ} & ( 6 ) \\ {b}_{j} = ( 1 - {a}_{j} ) {μ}_{j} & ( 7 )\end{matrix}$$

According to the calculations introduced in (2) to (7), aᵢ, ranging in [0, 1](note that the upper bound 1 can be reached only if ε is equal to 0), works as a weight when multiplied to Iᵢ as in (1), and b having the same dynamic range of Iᵢ, is like an offset. In smooth regions (as mentioned above, the criterion of being a smooth region or a high-variance region is given by ε), a approaches 0, and bᵢ is approximately the average of p in wᵢ, whereas in high-variance regions, aᵢ and bᵢ approach 1 and 0, respectively, and therefore edges are well preserved. It has been proved the GF filtering process is normalized, so no scaling is needed for a and b for energy conservation purpose.

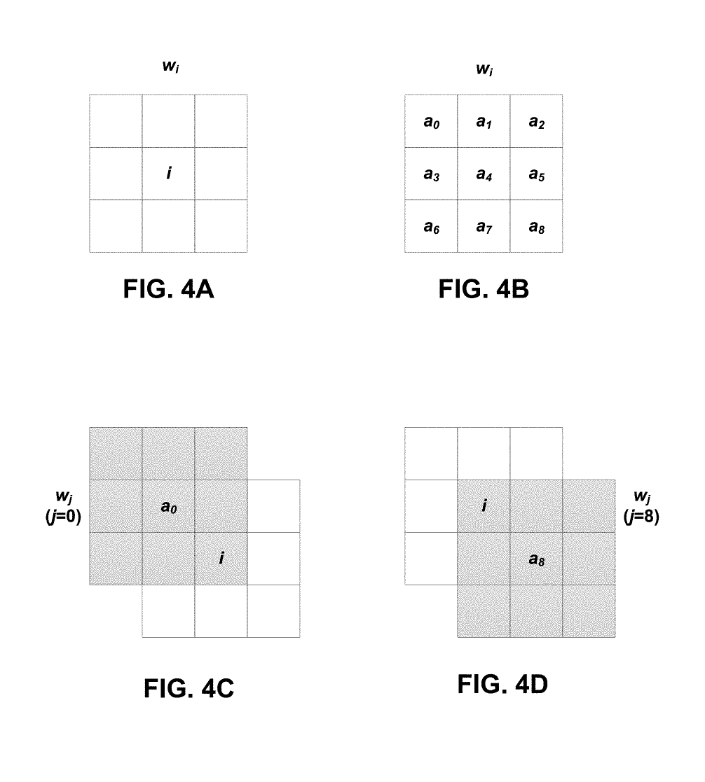

Calculation of aᵢ and bᵢ is further illustrated in FIGS. 4A-4D for a better understanding, assuming r is equal to 1 (i.e., 3×3 window). If aᵢ for pixel i (see FIG. 4A) is to be calculated, its 3×3 neighborhood is first denoted as window wᵢ, and all the aⱼ (j=0, 1, . . . , 8) for positions within wᵢ (see FIG. 4B)) need to be calculated, of which the average is aᵢ, as in (2). To calculate an aⱼ, position j's 3×3 neighborhood is denoted as window wⱼ. In FIGS. 4C and 4D, the gray areas are w₀ for a₀ and w₈ for a₈, respectively. Given wⱼ, the following four intermediate values are calculated, and substituted into (4):
1. μⱼ: the mean of I within wⱼ
2. σⱼ²: the variance of I within wⱼ
3. p̅ⱼ: the mean of p within wⱼ
4. Σ_{new}_{ⱼ}Iₙpₙ: the inner product of p and I within wⱼ

bⱼ is calculated using (5), when aⱼ is available. As can be seen, to calculate aᵢ and bᵢ for i, a supporting region of (4r+1)×(4r+1) is needed (e.g., a 5×5 supporting window is needed if r is equal to 1).

As introduced above, the GF filtering process can be decomposed into a few steps, most of which are box filtering with radius r, and can be efficiently computed in O(N) time (i.e., the computational complexity linearly increases with the number of pixels to be filtered and is independent to r) using integral image technique or a moving sum method. Considering the separability of the box filter, either method takes two operations (addition or subtraction) per pixel along each direction (x and y), and in total five additions or subtractions and one division (for normalization) per pixel. Therefore, GF filtering process is naturally a fast and non-approximate linear time algorithm.

In T. Vermeir, J. Slowack, S. Van Leuven, G. Van Wallendael, J. De Cock, R. Van de Walle, “Adaptive guided image filtering for screen content coding,” 2014 Int. Conf. Image Process., Oct. 27-30, 2014 (hereinafter “Vermeir”), the GF filtering process is used as a post-processing method to enhance the chroma components of 4:4:4 screen content videos distorted by compression. During the compression, the chroma components of the source are downsampled to ¼ the size (½ in each dimension) and coded as if the input color subsampling format is 4:2:0. On the decoding side, the chroma components are decoded and upsampled to the full resolution. By doing this, the chroma components, of which the delicate details are less likely to survive quantization, have even worse qualities caused by the additional resampling process. On the other hand, the luma component has much better quality. Since the luma and chroma components share the same edge structure (only the intensities are different), the GF filtering process uses the luma plane as the guidance image I to improve either of the chroma planes, Cb or Cr (i.e., Cb or Cr is the input image p). In terms of the two parameters ε and r, the former is fixed and the latter is region adaptive. As a result, the quality of the chroma components is significantly improved. However, note that since the value of r is not constant within an image, the aforementioned fast methods for box filtering cannot be implemented.

C. Chen, Z. Miao, B. Zeng, “Adaptive guided image filter for improved in-loop filtering in video coding,” 2015 Int. Workshop Multimedia Signal Process., Oct. 19-21, 2015 (hereinafter “Chen”) proposes the GF filtering process as an additional in-loop filter placed between deblocking and SAO for HEVC. Deblocking and SAO are the two in-loop filters in HEVC. More details about HEVC, deblocking, and SAO can be found in V. Sze, M. Budagavi, G. Sullivan, “High efficiency video coding (HEVC): algorithms and architectures,” Springer International Publishing, August 2014 (hereinafter “Sze”). It takes the image output from deblocking as both input image p and guidance image I, and does self-guided filtering. It uses fixed window size 3×3 (i.e., r is equal to 1) and adapts ε to local statistics.

The systems described in Vermeir and Chen use GF filtering described with respect to FIG. 3 without any modification and use exactly the same formulas defined by equations (1) to (7) above, although the systems described in Vermeir and Chen manipulate the inputs I, p, ε and r in different ways.

A more in-depth description of existing GF can be found in He 2010 and K. He, J. Sun, X. Tang, “Guided image filtering,” IEEE Trans. Pattern Anal. Mach. Intell., June 2013.

Video encoder 200 and video decoder 300 may also be configured to perform adaptive loop filtering (ALF), which as will be explained in greater detail below, may be used as an additional filter to GF and/or may be used for generating an input image for a GF. Generally, ALF minimizes the SSE between the input image and the source image by applying an FIR filter to the input image. The FIR filter is derived by least squares (LS) estimator. Denote the input image asp, the source image as S, and the FIR filter as h, and the following expression of SSE should be minimized, where (x, y) means any pixel position in p or S.

SSE=Σ_{x,y}(Σ_{i,j}h(i,j)p(x−i,y−j)−S(x,y))² (7)

The optimal h, denoted as hₒₚₜ, can be obtained by making the partial derivative of (7) with respect to h(i, j) equal to 0, as in (8).

$$\frac{\partial SSE}{\partial h ( i , j )} = 0 \qquad ( 8 )$$

After a few analytical steps, the Wiener-Hopf equation is obtained as in (9), of which the solution is hₒₚₜ.

Σ_{i,j}hₒₚₜ(i,j)(Σ_{x,y}p(x−i,y−j)p(x−m,y−n))=Σ_{x,y}S(x,y)p(x−m,y−n) (9)

The gain of ALF may be limited, if only one optimal filter is derived and applied to the whole image without any adaptation. The implementation of ALF set forth in M. Karczewicz, L. Zhang, W.-J. Chien, X. Li, “Improvements on adaptive loop filter,” JVET proposal JVET-B0060, Feb. 20-26, 2016 (hereinafter “B0060”) and JEM 6.0 repository: https://jvet.hhi.fraunhofer.de/svn/svn_HMJEMSoftware/tags/HM-16.6-JEM-6.0/ (hereinafter “JEM 6.0”) is more complicated than the one-optimal filter version of ALF described above. The ALF of JEM 6.0 includes the following design elements.
1. All the pixels in p are classified into C categories (C can be as many as 25), according to their local activities (i.e., flat or high variance) and gradient directions. C optimal filters are derived to be applied to the pixels in the corresponding categories, respectively.
2. The number of filter taps is adaptive at the frame level. Theoretically, filters with more taps can achieve lower SSE, but may not be a good choice in terms of Rate-Distortion (R-D) cost, because they may become a heavy overhead burned when transmitted, especially for low resolution videos. Sometimes, filters with less taps are chosen, as they are light and cause little SSE increase.
3. The filter coefficients may be predicted, and only the prediction errors (if any) are transmitted. The prediction pool consists of a bunch of pre-defined filters (16 candidates for each category) and a set of temporal predictions (i.e., the filters derived, used, and buffered when coding previous frames). The best candidate is selected for each filter.
4. ALF can be turned on and off on a block basis, of which the unit is adaptively selected at the frame level, and can be as small as 8×8 and as large as 128×128.

The current ALF is very efficient in reducing SSE and flexible in making the trade-off for the best R-D performance, thus improving video coding efficiency.

As part of performing ALF, video encoder 200 and video decoder 300 may perform pixel classification and filter derivation. Pixel classification and filter derivation generally refers to how the pixels in a frame are classified and how the filter coefficients for each category are calculated.

First, the input frame p is divided into non-overlapped 2×2 blocks, in which the four pixels are classified into one category based on local statistics (more details can be found in B0060 and JEM 6.0). Initially, all the pixels are classified into 25 categories, denoted as Cₖ (k=0, 1, . . . , 24).

As described above, current implementations of ALF introduce prediction to filter coefficients, where a best prediction is first selected from the pool for Cₖ, denoted as h_{pred,k}. The SSE of Cₖ can be minimized, equation (7) above can be re-written as equation (10), as below:

SSEₖ=Σ_{x,y}(Σ_{i,j}(h_{pred,k}(i,j)+h_{Δ,k}(i,j))p(x−i,y−j)−S(x,y))²,k=0, . . . ,24,(x,y)ϵCₖ (10)

where k_{Δ,k} is the difference between the optimal filter for Cₖ and h_{pred,k}. Denote Σ_{i,j}h_{pred,k}(i,j)p(x−i,y−j) as p′(x, y), meaning the result of filtering pixel p(x, y) by h_{pred,k}, and (10) can be re-written as in (11),

SSEₖ=_{x,y}(Σ_{i,j}h_{Δ,k}(i,j)p(x−i,y−j)−S(x,y)−p′(x,y)))²k=0, . . . ,24,(x,y)ϵCₖ (11)

By making the partial derivative of SSEₖ with respect to h_{Δ,k}(i,j) equal to 0, the modified Wiener-Hopf equation is obtained as in (12).

Σ_{i,j}h_{Δ,k}(i,j)(Σ_{x,y}p(x−i,y−j)p(x−m,y−n))=Σ_{x,y}(S(x,y)−p′(x,y))p(x−m,y−n) (12)

k=0, . . . ,24,(x,y)ϵCₖ

For the simplicity of expression, Σ_{x,y}p(x−i, y−j)p(x−m, y−n) and Σ_{x,y}(S(x, y)−p′(x, y))p(x−m, y−n) with (x, y)ϵCₖ (as shown in (12)) are denoted as R_{pp,k}(i−m,j−n) and R′_{ps,k}(m, n), respectively. Then, (12) can be re-written as (13).

Σ_{i,j}h_{Δ,k}(i,j)R_{pp,k}(i−m,j−n)=R′_{ps,k}(m,n)k=0, . . . ,24 (13)

Note that for every Cₖ, R_{pp,k}(i−m,j−n) and R′_{ps,k}(m,n) are cumulated over all the (x, y) in it, and will later be use in ALF parameter optimization.

In the current ALF, only the difference between the optimal filter and its prediction is calculated and transmitted. Note that if none of the filter candidates available in the pool is good enough to be selected, the identity filter (i.e., the filter with only one non-zero coefficient equal to 1 at the center makes the input and output identical) will be used as the prediction.

However, the ALF process with 25 filters for 25 categories is very rarely used, because the overhead burden is not affordable for most of the bitstreams. Therefore, the pixels in certain categories must be merged to one category, in order to reduce the number of filters to be transmitted and thus reduce the overhead bits. The cost of merging two categories is SSE increase. Consider two categories Cₘ and Cₙ, of which the SSEs are SSEₘ and SSEₙ, respectively, and their merged category is denoted as Cₘ₊ₙ with SSE, denoted as SSEₘ₊ₙ, which is always greater than or equal to SSEₘ+SSEₙ. Denote the increased SSE caused by merging Cₘ and Cₙ as ΔSSEₘ₊ₙ, which is equal to SSEₘ₊ₙ−(SSEₘ+SSEₙ). A fast algorithm is used in the current ALF to calculate ΔSSEₘ₊ₙ, instead of filtering all the pixels in Cₘ, Cₙ, and Cₘ₊ₙ and calculating SSEₘ, SSEₙ, and SSEₘ₊ₙ directly.

Equation (11), where SSEₖ is expressed, can be expanded, using some algebra manipulations, the equation (14) can be obtained.

$$\begin{matrix}{SSE}_{k} = {\sum }_{u , v} {h}_{Δ , k} ( u , v ) \\ = [ \begin{matrix}{\sum }_{i , j} {h}_{Δ , k} ( i , j ) {R}_{pp , k} ( i , u , j - v ) - \\ {R}_{p s , k}^{′} ( u , v )\end{matrix} ] - \\ {\sum }_{u , v} {h}_{Δ , k} ( u , v ) {R}_{p s , k}^{′} ( u , v ) + \\ {\sum }_{x , y} {( S ( x , y ) - {p}^{′} ( x , y ) )}^{2} {\vert}_{( x , y ) ∈ {C}_{k}} \\ = - {\sum }_{u , v} {h}_{Δ , k} ( u , v ) {R}_{p s , k}^{′} ( u , v ) + {R}_{ss , k}\end{matrix} \qquad ( 14 )$$

In (14), the red term is equal to 0 per (13), and the blue term and the green term, denoted as R_{ss,k}, have already been cumulated over all (x, y) in Cₖ, and are ready to be used to calculate SSEₖ.

To calculate SSEₘ₊ₙ, one needs to derive h_{Δ,m+n} the filter prediction error for Cₘ₊ₙ, by using (15).

Σ_{i,j}h_{Δ,m+n}(i,j)(R_{pp,m}(i−u,j−v)+R_{pp,n}(i−u,j−v))=R′_{ps,m}(u,v)+R′_{ps,n}(u,v) (15)

Similar to (14), the SSE for the merged category Cₘ₊ₙ can be calculated as in (16).

SSEₘ₊ₙ=−Σ_{u,v}h_{Δ,m+n}(u,v)(R′_{ps,m}(u,v)+R′_{ps,n}(u,v))(R_{ss,m}+R_{ss,n}) (16)

To reduce the number of categories from N to N−1, one needs to find the two categories Cₘ and Cₙ, of which the SSE increase ΔSSEₘ₊ₙ is smaller than that of any other combinations. The current ALF does the full search, which means all the

$${C}_{N}^{2} = \frac{N ( N - 1 )}{2}$$

combinations are tried one by one, and finds the combination with the lowest merge cost. The full search is otherwise impossible without using the aforementioned fast algorithm.

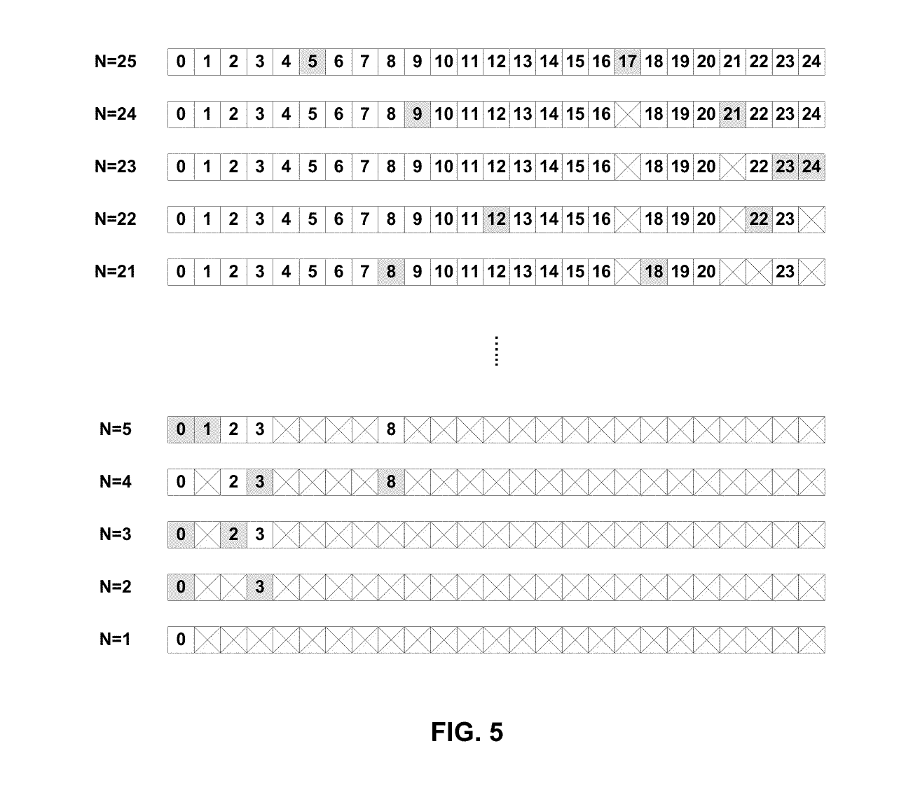

The ALF process for the current frame could potentially use numerous categories (e.g., the initial category number may be 25), which may be computationally complex. FIG. 5 illustrates an example of how the current ALF can reduce the number of categories. In this example, the ALF process starts with 25 categories, and does the full search to find the combination with the lowest merge cost (e.g., the combination of C₅ and C₁₇ in FIG. 5). Then, C₁₇ is merged into C₅, and labeled as unavailable. Note that for certain combination, the category with larger index is always merged into the other. While C₅ takes all the pixels from C₁₇, R_{pp,5}, R′_{ps,5}, and R_{ss,5} are updated as in (17), (18), and (19), respectively.

R_{pp,5}=R_{pp,5}+R_{pp,17} (17)

R′_{ps,5}=R′_{ps,5}+R′_{ps,17} (18)

R_{ss,5}=R_{ss,5}+R_{ss,17} (19)

The number of categories continues to be reduced until N is equal to 1, meaning all the pixels in the frame are in the same category and use the one filter. In FIG. 5, the categories in gray are the best combinations for each merge, and the categories marked with a cross are unavailable.

In short, for each merge, a desirable combination may be found by full search, the category with larger index n is labeled unavailable, and R_{pp,m}, R′_{ps,m}, and R_{ss,m} of the category with smaller index m are updated, as in (17) to (19).

As can be seen from FIG. 5, for each N (N=1, 2, . . . , 25), how the categories merge, together with N filters and SSE values (i.e., SSEₖ, k=0, 2, . . . , N−1, as in (14)) is well recorded. The optimal number of categories Nₒₚₜ is selected by the criterion of R-D cost, as in (20),

$${N}_{opt} = {arg min}_{N} ( J {\vert}_{N} = D {\vert}_{N} + λ R {\vert}_{N} ) \qquad ( 20 )$$

where D|_{N} is the total SSE of using N categories (D|_{N}=Σₖ₌₀^{N-1}SSEₖ), R|_{N} is the total number of bits used to code the N filters, and A is the weighting factor determined by the quantization parameter (QP). N providing the lowest R-D cost is selected as Nₒₚₜ.

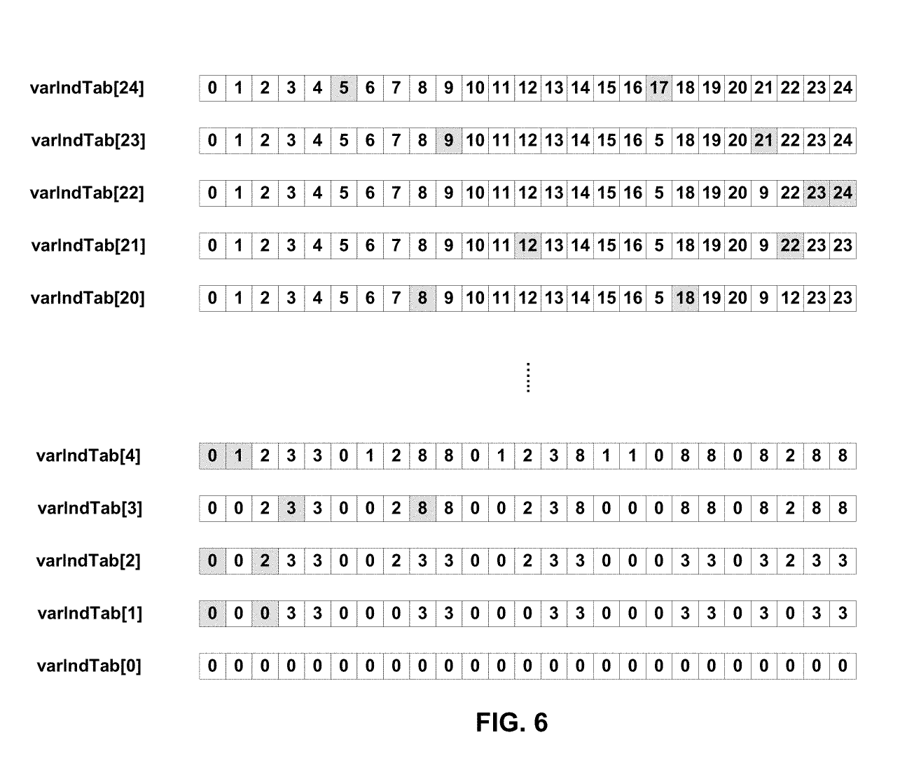

After the category merge, only N filters are transmitted, which is usually much smaller than its initial value 25. The pixels initially classified into categories that are labeled unavailable later still need to know which filter to use. In the current ALF, this kind of information is stored during the category merge in varIndTab[25][25], a 25×25 matrix, as shown in FIG. 6 (FIG. 6 uses the same example as in FIG. 5). Given that the number of categories is N (i.e., there are N filters), the line varIndTab[N−1] carries the information of how every filter is shared by merged categories. For example, in varIndTab[24](N=25), all the categories are labeled with different filter indices from 0 to 24. Then, C₅ and C₁₇ are merged and N reduces to 24. The position of C₁₇ is labeled by 5, meaning C₅ and C₁₇ share the same filter. For another example, in varIndTab[4] (N=5), C₀ and C₁ are merged, and therefore in varIndTab[3], all the positions which were previously labeled as 1 are now labeled as 0. Given varIndTab[N−1], all the categories labeled with the same index share the same filter. This process occurs recursively until N is 1.

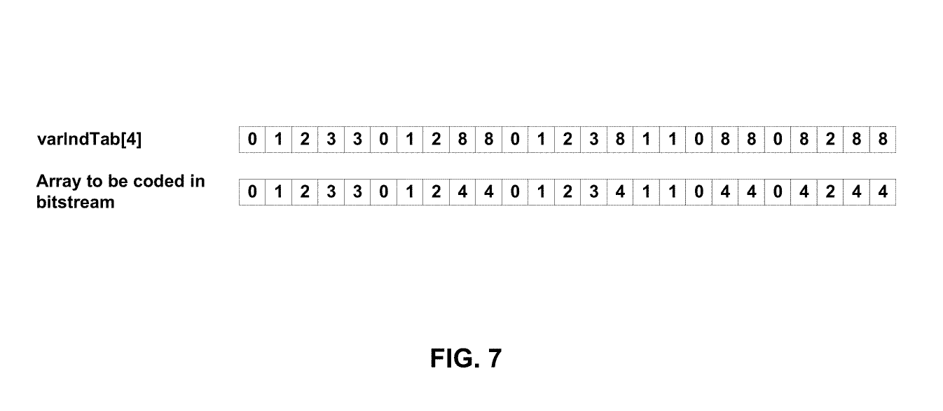

Although varIndTab[25][25] saves the information for all the possible N, only the information in varIndTab[Nₒₚₜ−1] will be transmitted, after Nₒₚₜ is determined by (20). Note that the numbers in varIndTab[Nₒₚₜ−1] are first converted into filter indices, ranging from 0 to N−1, before transmitted, because smaller numbers always consume less bits. Take the same example as in FIGS. 5 and 6, and assume Nₒₚₜ is 5, the numbers in varIndTab[4] are converted as shown in FIG. 7, where the categories labeled with 8 will be sharing filter #4.

As part of performing ALF, video encoder 200 and video decoder 300 may be configured to perform quantization of filter coefficients. h_{Δ,k} calculated by (13) has real-valued (continuous) coefficients, of which the summation is zero. For integer arithmetic implementation, the coefficients in h_{Δ,k} should be quantized into 2^{Q} steps (Q is equal to 10 in the current ALF), and be represented by the quantization levels, denoted as f_{Δ,k}. The simplest way to generate f_{Δ,k} is “scaling and rounding,” as shown in (21).

f_{Δ,k}=round(h_{Δ,k}×512) (21)

where the function round(x) finds the closest integer to x. However, the rounding operation cannot guarantee the summation of the coefficients in f_{Δ,k} is zero, which may cause energy change before and after the filtering. Therefore, if the summation, checked after (21) is done, is not zero, further adjustments on individual coefficients are needed, as introduced below.

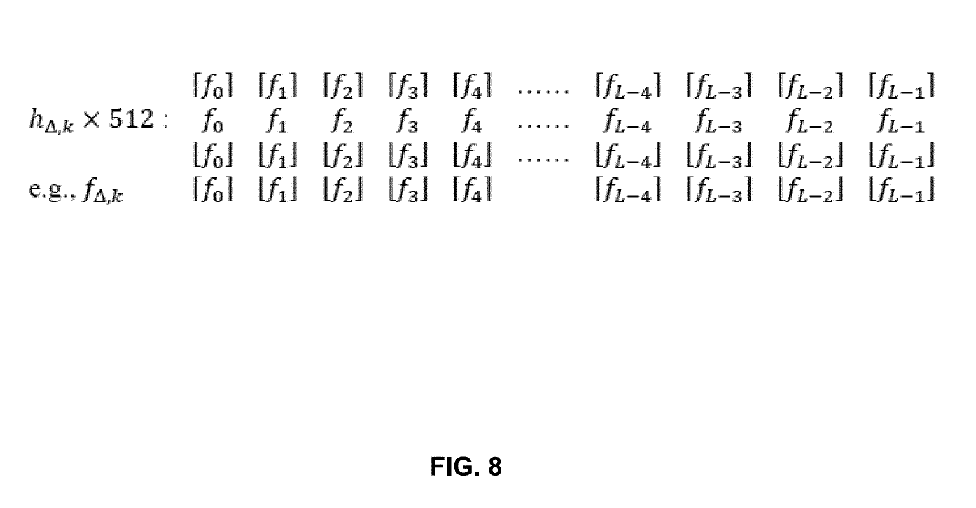

Assuming the filter length is L, the second line of FIG. 8 represents h_{Δ,k}×512, which are still real-valued. Each element, fₙ (n=0, 1, . . . , L−1), can be adjusted to either [fₙ](i.e., the smallest integer greater than fₙ, a.k.a., the ceiling) or |fₙ| (i.e., the largest integer smaller than fₙ, a.k.a., the floor), as long as the summation of f_{Δ,k} coefficients is zero. This condition is very loose, and there are a bunch of satisfying combinations (the bottom line in FIG. 8 shows an example). The best combination, which produces the smallest SSE, should be selected. To calculate the SSE for every valid combination f_{Δ,k}, the current ALF directly uses the equation in (14), which is the expanded version of (11), as a fast algorithm, instead of literally performing the filtering on the category k. Note that h_{Δ,k} in (14) is replaced by f′_{Δ,l}=h_{Δ,k}/512 (i.e., the normalized version of f_{Δ,k}), which is not the solution of (13), and therefore the red term is not equal to zero and (14) is re-written as in (22),

SSEₖ=Σ_{u,v}f′_{Δ,k}(u,v)Σ_{i,j}f′_{Δ,k}(i,j)R_{pp,k}(i−u,j−V)−2 Σ_{u,v}f′_{Δ,k}(u,v)R′_{ps,k}(u,v)+R_{ss,k} (22)

where R_{pp,k}, R′_{ps,k}, and R_{ss,k} are cumulated for all Cₖ (k=0, 1, . . . , 24) initially and updated during the category merge process.

The output of ALF filtering process for pixel (x, y) belonging to Cₖ is denoted as p_{ALF}(x, y), and is shown in (23).

p_{ALF}(x,y)=[Σ_{i,j}(f_{Δ,k}(i,j)+f_{pred,k}(i,j))p(x−i,y−j)+2⁸]>>9 (23)

The ALF process of JEM 6.0 and optimizations are described in more detail in J. Chen, E. Alshina, G. J. Sullivan, J.-R. Ohm, J. Boyce, “Algorithm description of Joint Exploration Test Model 6 (JEM6),” JVET-F1001, April 2017.

The block-based hybrid video coding is a framework that many modern video coding standards, such as MPEG-2, H.264/AVC, and H.266/HEVC, use. Hybrid video coding refers to the combination of prediction (inter or intra) and transform coding. Prediction-based coding exploits the temporal and spatial correlations of video frames, while transform coding removes the spatial redundancy of the prediction error. The designation “block-based” means each video frame is divided into non-overlapping block. The hybrid coding is applied to each block.

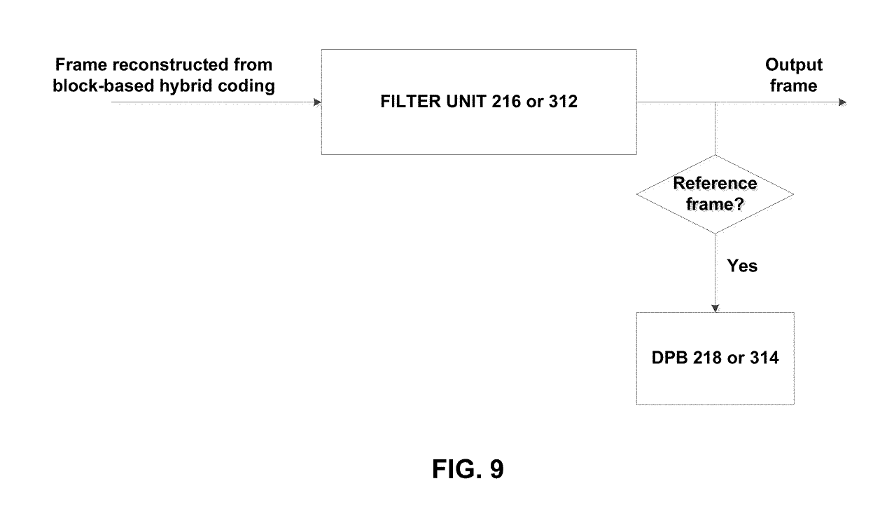

FIG. 9 is a flowchart illustrating the in-loop filtering stage in a video coding framework, as may be performed by video encoder 200 or video decoder 300. In the example of FIG. 9, a frame reconstructed from block-based hybrid coding, e.g., the reconstruction unit 214 or summer 310 described in more detail with reference to FIGS. 19 and 20 below, is input to filter unit 216 or 312. Filter unit 216 or 312 filters the input frame in the manner described in this disclosure to generate an output frame. If the output frame is to be used as a reference frame for coding future frames, then a copy of the output frame is stored in decoded picture buffer (DPB) 218 or 314, described in more detail below with respect to FIGS. 19 and 20.

After all the blocks in a frame are processed by the hybrid video coding, that frame is reconstructed, with the reconstructed frame typically being a degraded version of the original frame due to the quantization in transform coding. The reconstructed frame is usually not directly used as the output for display or the input to DPB for future reference if it is a reference frame for inter coding. Instead, it is improved with one more step, so called in-loop filtering, before output, as shown in FIG. 9. Note that the in-loop filtering can also be performed in a block-based fashion, but not necessarily.

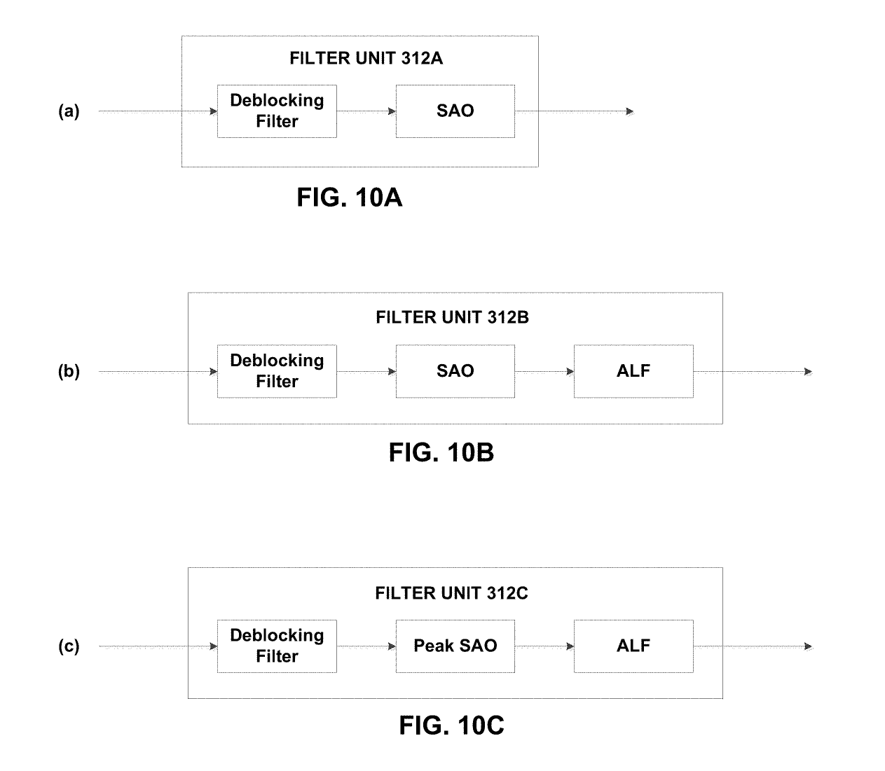

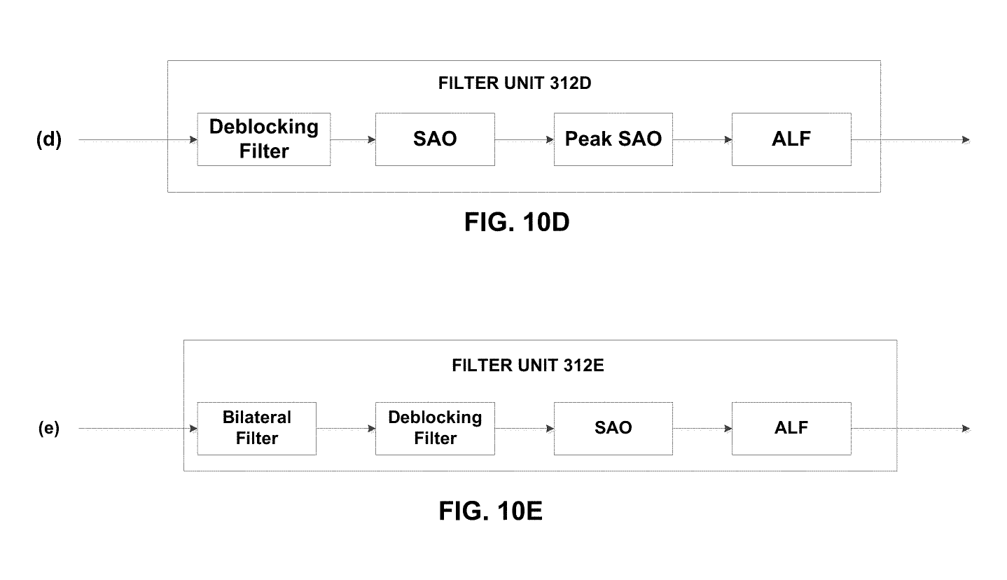

FIGS. 10A-10E show example arrangements for filter unit 312, which may be configured to perform in-loop filtering, for example, inside the in-loop filtering block in FIG. 9. The various examples of FIGS. 10A-10E are shown as filter units 312A-312E, respectively, any of which may be implemented either as filter unit 312 or as a portion of filter unit 312, as described in more detail elsewhere in this document. In the examples of FIGS. 10A-10E, several filters for different purposes are concatenated within filter unit. Filter unit 312 may be a component of video decoder 300. Filter unit 312, and how filter unit 312 interacts with other components of video decoder 300 will be described in more detail with respect to FIG. 20. Filter unit 216 of video encoder 200 (described in more detail with respect to FIG. 19) may generally be configured to perform the same techniques as filter unit 312.

FIGS. 10A-10E give five examples of how such filters may be arranged, although it is contemplated that other arrangements may also be used. The technical details of the examples and the individual filters can be found in Sze for FIG. 10A, B0060 for FIG. 10B, M. Karczewicz, L. Zhang, J. Chen, W.-J. Chien, “EE2: Peak Sample Adaptive Offset,” JVET proposal JVET-E0066, Jan. 12-20, 2017 for FIGS. 10C and 10D, and JEM 6.0 for FIG. 10E.

Applying multiple filters serially may cause some potential problems. First, the gains from individual filters are generally not additive, and in many instances, the gains achieved from jointly using several filters is only slightly higher than using one filter. Second, to do the logical controls of some filters, a lot of information generated in the block-based hybrid coding stage, such as block splitting, coding mode, and QP, is needed, which increases the memory requirement and data fetch burden. Third, the long pipelines, as shown in FIGS. 10A-10E, cause large encoding and decoding latency. Fourth, the more the filters are included, the higher the implementation complexity and cost are, despite that some filters have low computational complexity.

This disclosure proposes techniques that may address the potential problems outlined above. More specifically, this disclosure describes a new filter for in-loop filtering, of which the gain is comparable to the joint use of two or more existing filters. By achieving this target, the serial use of several filters may potentially be replaced by the filter of this disclosure, thus shortening the pipeline and reducing the implementation cost. The proposed filter is also designed to be isolated from the block-based hybrid coding stage, to avoid additional memory requirement and data fetch burden.

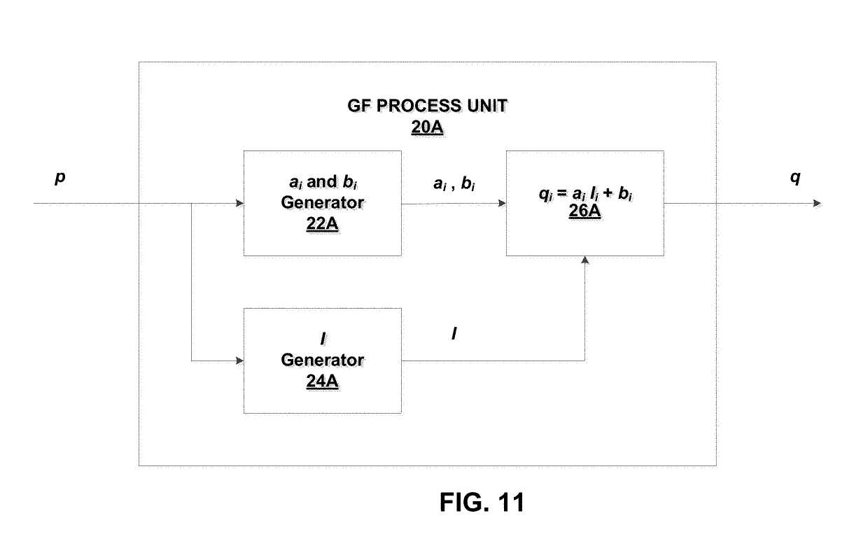

FIG. 11 shows a diagram for a modified GF process unit 20A that may be implemented as a component of video encoder 200 and video decoder 300 as, for example, a sub-component of filter unit 216 or filter unit 312, which are described in more detail with respect to FIGS. 19 and 20, respectively. The GF process unit 20A of FIG. 11 may be used in the in-loop filtering stage. In the example of FIG. 11, GF process unit 20A includes ai and bi generator 22A, I generator 24A, and qi determination unit 26A. In the example of FIG. 11, ai and bi generator 22A and qᵢ generator 24A receive a guidance image I. Based on p, ai and bi generator 22A determines parameters aᵢ and bᵢ, and I generator 24A determines guidance image I. Based on the parameters ai and bi and guidance image I, qᵢ determination unit 26A determines output image q.

GF process unit 20A of FIG. 11 is different than GF process unit 10 of FIG. 3 in at least two aspects. First, aᵢ and bᵢ generator 22A takes only p as the input to generate parameters aᵢ and bᵢ for pixel i. Second, the guidance image I is not given beforehand, but instead is generated by I generator 24A.

The modified GF process unit 20A of FIG. 11 also includes aᵢ and bᵢ generator 22A, which takes p, together with two parameters r and ε (all have the same physical meanings as introduced above) as the input, and uses the same equations of (2) and (3) to calculate a and b for pixel i, but uses (24) and (25) to calculate aⱼ and bⱼ,

$$\begin{matrix}{a}_{j} = \frac{{\overline{σ}}_{j}^{2}}{{\overline{σ}}_{j}^{2} + ɛ} & ( 24 ) \\ {b}_{j} = ( 1 - {a}_{j} ) {\overline{p}}_{j} & ( 25 )\end{matrix}$$

where p̅ⱼ and σ̅ⱼ² are the mean and variance of p within wⱼ, respectively. The window radius r is empirically set to be 1 (i.e., wⱼ is a 3×3 window centered at pixel j), which can provide the best performance according to our test results. Another advantage of using window size 3×3 is that the fast algorithms for box filtering (i.e., integral image technique or moving sum method as introduced above) can be replaced by 2-D separable [1 1 1]/3 filtering with the same number of operations, which is much easier to be implemented. The parameter ε is region-adaptive, and can be selected from 24 values, as shown in Table 1. The ε values in Table 1 can be directly used only if the pixel intensities in p are normalized into the range [0, 1]. Otherwise, the ε values should be scaled properly before used. This will be explained in greater detail below with respect to generating ai and bi using integer arithmetic.

TABLE 1
24 ε values used in the proposed GF

| | index | | | | | | | |
|---|---|---|---|---|---|---|---|---|
| | 0 | 1 | 2 | 3 | 4 | 5 | 6 | 7 |
| ε | 0 | 0.000001 | 0.000004 | 0.000009 | 0.000016 | 0.000025 | 0.000036 | 0.000049 |
| | index | | | | | | | |
| | 8 | 9 | 10 | 11 | 12 | 13 | 14 | 15 |
| ε | 0.000081 | 0.000144 | 0.000225 | 0.000324 | 0.000441 | 0.000576 | 0.000729 | 0.000900 |
| | index | | | | | | | |
| | 16 | 17 | 18 | 19 | 20 | 21 | 22 | 23 |
| ε | 0.001089 | 0.001296 | 0.001521 | 0.001764 | 0.002025 | 0.002304 | 0.002601 | 0.002916 |

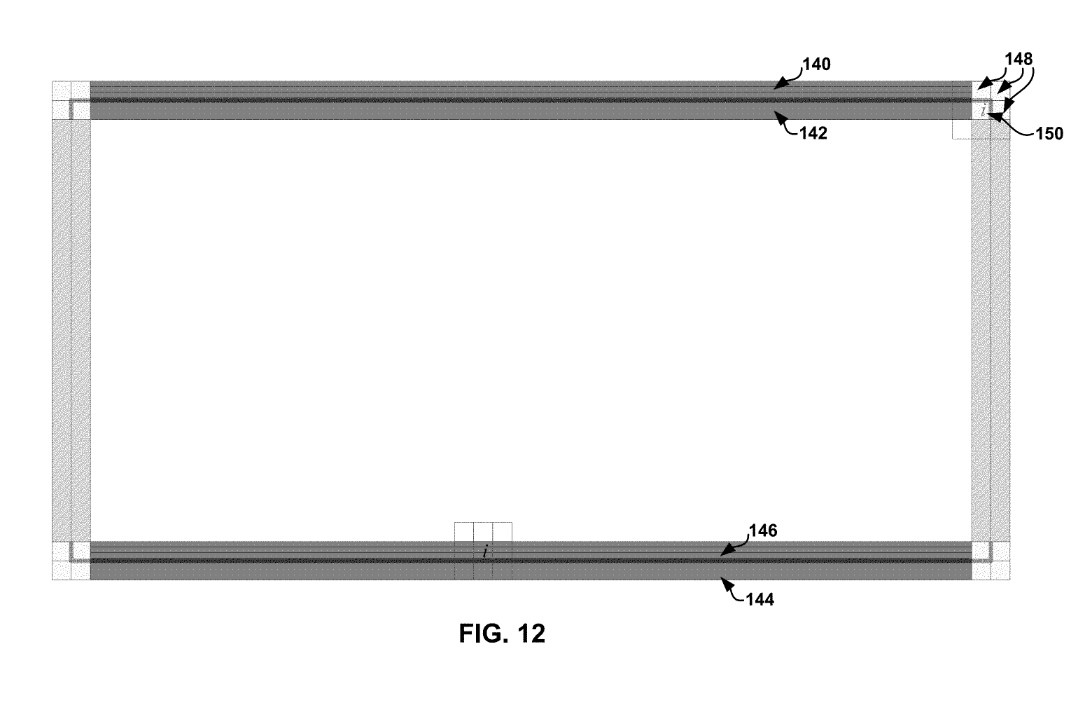

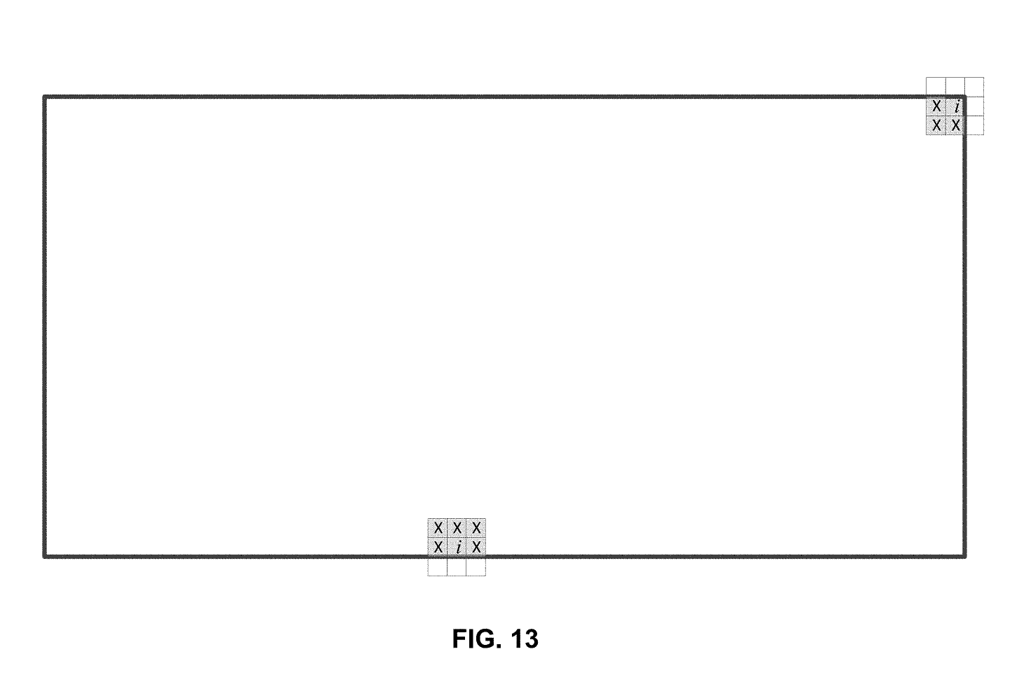

Video encoder 200 and video decoder 300 may also be configured to calculate a and b for boundary pixels. Some calculations in “aᵢ and bᵢ Generator,” such as (2), (3), (24), and (25), need supporting pixels from a (2r+1)×(2r+1) neighborhood. Sometimes, the center pixel (i.e., i or j) is on the frame boundary, such that the supporting pixels outside the frame boundary are unavailable. There are two methods to solve the problem, as illustrated by FIG. 12 and FIG. 13 (both use 3×3 window for example), respectively.

The first method is so called extended boundary, as shown in FIG. 12. The supporting pixels outside the frame boundary are generated and used as if available. The generation can be extrapolation filtering, or can be as simple as directly copying (e.g., in FIG. 12, the lines on the top of the frame (e.g., lines 142) from the top line (e.g., 142), the lines (e.g., 144) below the frame from the bottom line (e.g., 146), and the three pixels (e.g., 148) outside the frame corner are copied from the corner pixel inside the frame (e.g., 150).

The second method is so called restricted boundary, as shown in FIG. 13. The frame boundaries are not extended, and only the available pixels within the window are used to support the center pixel. Thus, the normalization factor 1/(2r+1)² (e.g., 1/9 for 3×3 window) should be replaced with 1/|w|, where |w| is the actual number of pixels available in the window. For example, pixel i in the upper-right corner has only four support pixels, and pixel i at the bottom has six.

Video encoder 200 and video decoder 300 may also be configured to generate aᵢ and bᵢ using integer arithmetic. The various calculations introduced above may need floating-point operations, which may be undesirable for software and hardware implementations. According to the techniques of this disclosure, the required floating-point operations may be approximated by 32-bit integer arithmetic without a performance penalty. The details are described below. Note that the examples below show a 3×3 window, i.e., the radius r is equal to 1, and 10-bit bit-depth. This specific implementation, however, can easily be extended to more general cases that include windows of different sized.

First, consider the case of restricted boundary (example shown in FIG. 13). To calculate aⱼ in (24), one needs to calculate p̅ⱼ, p̅ⱼ², σ̅ⱼ², as shown in (26), (27), and (28), respectively,

$$\begin{matrix}{\overline{p}}_{j} = \frac{1}{\vert w \vert} {\sum }_{l ∈ {w}_{j}} {p}_{l} & ( 26 ) \\ {\overline{p}}_{j}^{2} = \frac{1}{\vert w \vert} {\sum }_{l ∈ {w}_{j}} {p}_{l}^{2} & ( 27 ) \\ {\overline{σ}}_{j}^{2} = {\overline{p}}_{j}^{2} - {\overline{p}}_{j}^{2} & ( 28 )\end{matrix}$$

where |w|, the actual number of pixels in wⱼ, may be 9, 6, and 4, if j is an inside pixel, boundary pixel (see the window at the bottom of FIG. 13), and corner pixel (see the window at the upper-right corner of FIG. 13), respectively. To hold the divisions until the end of the process while maintaining the correct ratios among three kinds of pixels, scalars 4, 6, and 9 are multiplied to these three kinds of pixels, respectively, so that p̅ⱼ and p̅ⱼ² are always 36 times the magnitude of what they should be, no matter where the pixel j is in the frame. The dynamic range and bit-width (representing the dynamic range in the log 2 domain) of p̅ⱼ and p̅ⱼ² are shown in the top two lines of Table 2. The calculation of σ̅ⱼ² as in (28) is re-written in (29), because otherwise the two terms are not scaled at the same level.

σ̅ⱼ²=36×p̅ⱼ²−\dot{p}ⱼ² (28)

As shown in the third line of Table 2, the bit-width of σ̅ⱼ² (i.e., 30.3399 bits) is quite close to the upper bound 32 bits, and therefore a right shifting of 10 bits is applied to \dot{σ}ⱼ² before it is used in the next step.

TABLE 2
Dynamic range and bit-width in each step of integer
operations (restricted boundary)

| | Dynamic Range | Bit-Width (log₂ domain) |
|---|---|---|
| p̅ⱼ | [0, 2¹⁰ × 36] | 15.1699 |
| p̅ⱼ² | [0, 2¹⁰ × 2¹⁰ × 36] | 25.1699 |
| σ̅ⱼ² | [0, 2¹⁰ × 2¹⁰ × 36 × 36] | 30.3399 |
| σ̅ⱼ²/2⁶ | [0, 2¹⁰ × 36 × 36] | 20.3399 |
| aⱼ | [0, 2¹⁰] | 10 |
| bⱼ | [0, 2¹⁰ × 2¹⁰ × 36] | 25.1699 |
| aᵢ (intermediate) | [0, 2¹⁰ × 36] | 15.1699 |
| bᵢ (intermediate) | [0, 2¹⁰ × 2¹⁰ × 36 × 36] | 30.3399 |
| aᵢ (output) | [0, 2¹¹] | 11 |
| bᵢ (output) | [0, 2³⁰] | 30 |

Next, aⱼ is calculated as in (24). Note that the ε values given in Table 1 are for normalized σ̅ⱼ², of which the dynamic range is in [0, 1], and should not be directly substituted into (24). Since \dot{σ}ⱼ² has been scaled by 2¹⁰×36×36 to 20.3399 the bit-width (see the fourth line of Table 2), the ε values should be scaled as well, by multiplying 2¹⁰×36×36 and rounding, so as to have the same level as of σ̅ⱼ². The scaled ε values, as shown in Table 4, are used in (24).

TABLE 3
Dynamic range and bit-width in each step of integer
operations (extended boundary)

| | Dynamic Range | Bit-Width (log₂ domain) |
|---|---|---|
| p̅ⱼ | [0, 2¹⁰ × 9] | 13.1699 |
| p̅ⱼ² | [0, 2¹⁰ × 2¹⁰ × 9] | 23.1699 |
| σ̅ⱼ² | [0, 2¹⁰ × 2¹⁰ × 9 × 9] | 26.3399 |
| σ̅ⱼ²/2⁶ | [0, 2¹⁰ × 9 × 9] | 20.3399 |
| aⱼ | [0, 2¹⁰] | 10 |
| bⱼ | [0, 2¹⁰ × 2¹⁰ × 9] | 23.1699 |
| aᵢ (intermediate) | [0, 2¹⁰ × 9] | 13.1699 |
| bᵢ (intermediate) | [0, 2¹⁰ × 2¹⁰ × 9 × 9] | 26.3399 |
| aᵢ (output) | [0, 2¹¹] | 11 |
| bᵢ (output) | [0, 2³⁰] | 30 |

TABLE 4
24 integer ε values, scaled due to the integer approximation

| | index | | | | | | | |
|---|---|---|---|---|---|---|---|---|
| | 0 | 1 | 2 | 3 | 4 | 5 | 6 | 7 |
| ε | 0 | 1 | 5 | 12 | 21 | 33 | 48 | 65 |
| | index | | | | | | | |
| | 8 | 9 | 10 | 11 | 12 | 13 | 14 | 15 |
| ε | 107 | 191 | 299 | 430 | 585 | 764 | 967 | 1194 |
| | index | | | | | | | |
| | 16 | 17 | 18 | 19 | 20 | 21 | 22 | 23 |
| ε | 1445 | 1720 | 2019 | 2341 | 2687 | 3058 | 3452 | 3870 |

The integer implementation of (24) is shown in (29), as below.

$${a}_{j} = ⌊ \frac{( {\overline{σ}}_{j}^{2} << 10 ) + [ ( {\overline{σ}}_{j}^{2} + ɛ ) >> 1 ]}{{\overline{σ}}_{j}^{2} + ɛ} ⌋ \qquad ( 29 )$$

Therefore, aⱼ, of which the original range is [0, 1], is kept in 10-bit precision. And bⱼ, of which the original range is [0, 2¹⁰], is calculated using (30).

bⱼ=(2¹⁰−aⱼ)p̅ⱼ (30)

Then, aᵢ and bᵢ, the average of all the possible aⱼ and bⱼ, respectively, in window wᵢ, are calculated. Since the box filtering is used, the problem of using different normalization factors for inside, boundary, and corner pixels occurs again, and is solved in the same way as for calculating p̅ⱼ and p̅ⱼ². Therefore, aᵢ and bᵢ are 36 times the magnitude of aⱼ and bⱼ, respectively.

Finally, all the divisions for normalization held until the end of the process are performed by multiplication and shifting, as in (31) and (32) below, so the dynamic ranges of the output aᵢ and bᵢ are the integer powers of 2.

aᵢ=(aᵢ×29127+2¹⁸)>>19 (31)

bᵢ=[(bᵢ+2⁹)>>10]×809 (32)

Note that the dynamic ranges of the output aᵢ and bᵢ are still larger than what may desirable, and final right shifting may be performed by qᵢ determination unit 26, in a manner that will be described in more detail below.

The above integer implementation is designed for the case of restricted boundary (see FIG. 13). For the case of extended boundary, in which the problem of using different normalization factors for inside, boundary, and corner pixels does not exist (i.e., the factor is 9 for all pixels), and therefore the operations of multiplying the inside, boundary, and corner pixels with scalars 4, 6, and 9, respectively, are saved. Without any additional scaling, the output of the box filtering for p̅ⱼ, p̅ⱼ², aᵢ, and bᵢ is naturally 9 times the magnitude of what they should be, if divisions are held to be done at the end of the process.

Table 3, like Table 2, summarizes the integer implementation for the case of extended boundary. One difference is that only 6-bit right shifting is applied on σ̅ⱼ² (see the fourth line of Table 3) to achieve the 20.3399 bit-width. Yet another difference is that the equations to calculate the final aᵢ and bᵢ are changed to (33) and (34) as below.

aᵢ=(aᵢ×29127+2¹⁶)>>17 (33)

bᵢ=[(bᵢ+2⁵)>>6]×809 (34)

There is another problem to be addressed. The variance σ̅ⱼ², calculated using (28), can sometimes have very small value (e.g., pixel j is in a smooth region), though its dynamic range is large. The small-valued σ̅ⱼ² is further right shifted 10 or 6 bits to be used in (29) to calculate aⱼ. In this case, aⱼ may have great difference with its real-valued version, meaning aⱼ becomes inaccurate caused by such integer approximation. To solve this problem, a threshold, denoted as th, is pre-defined (e.g., th is equal to 2²⁰ for one example) for σ̅ⱼ² obtained by (28), and (th<<10) shall not exceed 2³². If σ̅ⱼ² is greater than the threshold, meaning the value of σ̅ⱼ² is far from small enough to cause the problem, all the steps introduced above are followed without any change. Otherwise, the right shifting is not performed (i.e., the fourth line in Table 2 or 3 is skipped), and the ε values in Table 1 are scaled with (2¹⁰×2¹⁰×36×36) or (2¹⁰×2×9×9) for the case of restricted boundary or extended boundary, respectively, and rounded, before used in (29).

Video encoder 200 and video decoder 300 may also be configured to generate I using an I Generator. Generally, “I Generator” can be any function that takes p as the input and outputs the guidance image I with higher quality. This section provides the details of the GF filtering process with ALF introduced above as the “I Generator”.

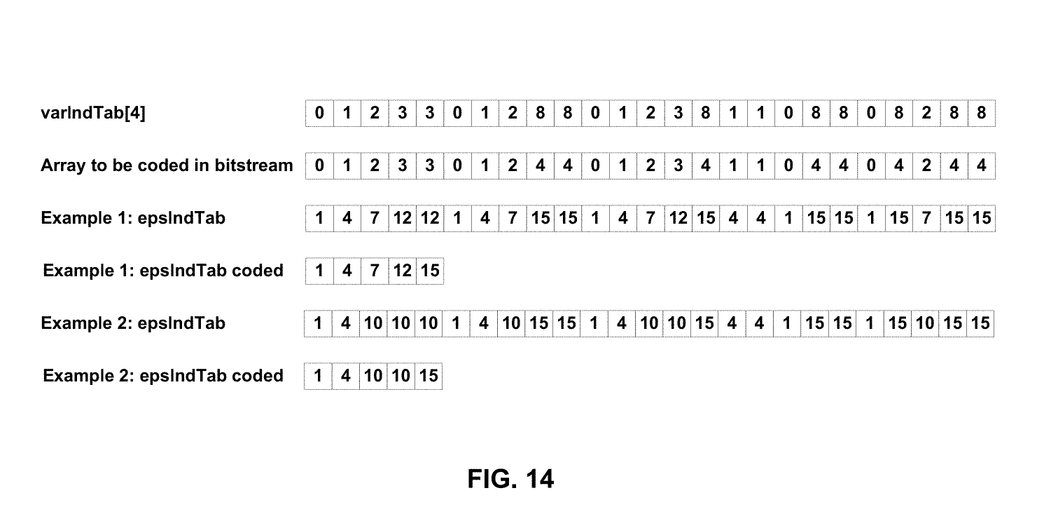

First, the pixels in the same ALF category use the same ε value for GF filtering. The optimal ε value for certain ALF category is selected from the 24 values shown in Table 1 by some encoder-side optimization methods, which will be described in more detail below. FIG. 14 gives two examples of how to associate each ALF category with an e value by using epsIndTab, a 1-D 25-entry array storing the indices of ε values. Note that the category merge information stored in varIndTab is from FIG. 7. In Example 1, different ALF categories are associated with different ε values (e.g., C₁ with ε#4, C₈ with ε#15, etc.). Since there are totally 5 categories, five ε indices corresponding to each category (instead of all the 25 indices in epsIndTab) are coded into the bitstream. It is also allowed that different ALF categories are associated with the same ε value. In Example 2, the pixels in C₂ or C₃ use ε #10 for GF filtering. Note that ε index 10 should be coded into the bitstream twice to correspond to C₂ and C₃, respectively.

Second, the filtering process of the current ALF, originally shown in (23), is modified as (35) below,

p_{ALF}(x,y)=Σ_{i,j}(f_{Δ,k}(i,j)+f_{pred,k}(i,j)p(x−i,y−j) (35)

where the 9-bit right shifting is saved to preserve high intermediate precision and may be performed later by qᵢ determination unit 26.

As introduced above, GF process unit 20A of FIG. 11 includes qi determination unit 22. Theoretically, Ii, the output of ALF process, has the same bit-depth as of the input (i.e., 10 bits); ai, working as a weighting factor, has dynamic range [0, 1]; bi, like an offset, has the same dynamic range as of Ii. However, as the inputs to qi determination unit 26, ai, bi, and Ii, may all be represented by integers in much higher precisions (i.e., ai with 11 bits, bi with 30 bits, and Ii with 19 bits). All the extra intermediate precisions will be removed by one right shifting at the very end of the whole GF filtering process, as shown in (36).

qᵢ=(aᵢIᵢ+bᵢ+2¹⁹)>>20 (36)

The proposed GF filtering process of this disclosure can be used as an additional in-loop filter that is serially added into the in-loop filtering block, just like the other filters in FIGS. 10A-10E. As discussed above, however, using the GF as an additional filter potentially presents performance trade offs.

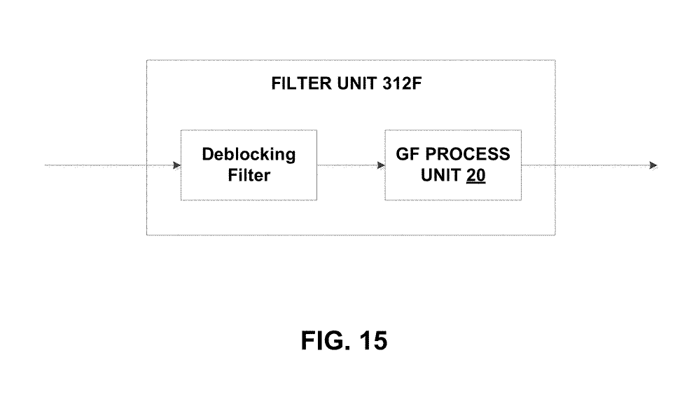

FIG. 15 shows an example implementation of filter unit 312 (shown as filter unit 312F in FIG. 15) in which only deblocking filter and GF are performed by filter unit 312. Filter unit 312F may be implemented either as filter unit 312 or as a portion of filter unit 312, as described in more detail elsewhere in this document. As can be seen in the example of FIG. 15, a deblocking filter precedes GF process unit 20 in filter unit 312F. It may be desirable to keep the deblocking filter functionality in filter unit 312F because, otherwise, blocking artifacts can become readily obvious to a viewer and diminish the viewing experience. By using fewer filters, the pipeline of filter unit 312F may be shortened, and the implementation cost may be significantly reduced. In terms of performance, for performing in-loop filtering, the implementation of filter unit 312F shown in FIG. 15 may, for some criteria, outperform the implementations of filter units 312A-E shown in FIGS. 10A-10E. GF process unit 20 of FIG. 15 may, for example, take the form of any of GF process units 20A-20D.

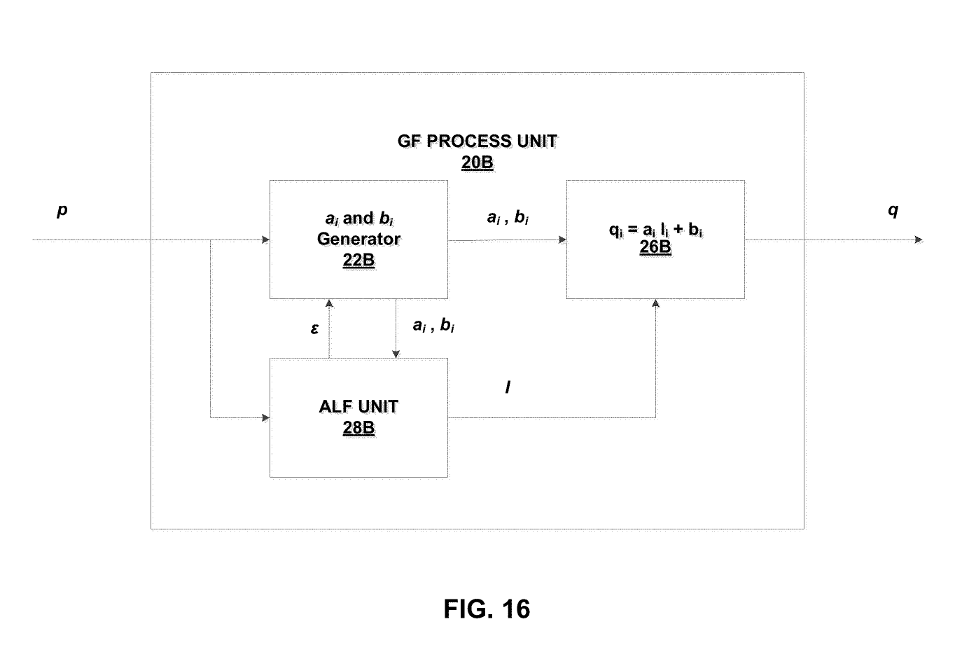

FIG. 16 shows an alternative implementation of GF process unit 20, shown as GF process unit 20B. The implementation of GF process unit 20B in FIG. 16 may, for example, be used as an encoder optimization of the proposed GF filtering process with ALF unit 28B used as the I Generator 24B. With ALF unit 28B included in GF process unit 20B, the encoder-side optimization introduced above may be changed accordingly.

As part of performing GF, video encoder 200 and video decoder 300 may be configured to perform filter derivation. A difference between filter derivation for ALF used as an independent filter and the functionality performed by ALF unit 28B in GF process unit 20B is that ALF, when used as an independent filter, is optimized to minimize the SSE between its output and the source, as explained above with respect to equation (7). However, ALF unit 28B inside GF process unit 20B may be optimized to produce the optimal guidance I, such that the SSE between the GF output q and the source is minimized, as shown in equation (37).

$$\begin{matrix}SSE = {\sum }_{x , y} {( q ( x , y ) - S ( x , y ) )}^{2} \\ = {\sum }_{x , y} {( a ( x , y ) I ( x , y ) + b ( x , y ) - S ( x , y ) )}^{2} \\ = {\sum }_{x , y} {( \begin{matrix}a ( x , y ) ( {\sum }_{i , j} h ( i , j ) p ( x - i , y - j ) ) + \\ b ( x , y ) - S ( x , y )\end{matrix} )}^{2}\end{matrix} \qquad ( 37 )$$

In this instance, a(x, y) and b(x, y) are equivalent to aᵢ and bᵢ, except the coordinates are expressed by (x, y). Taking the pixel classification and filter prediction, as described above, into consideration, equation (37) may be rewritten specially for Cₖ, as equation (38) below:

SSEₖ=Σ_{x,y}(aₖ(x,y)[Σ_{i,j}(h_{pred,k}(i,j)+h_{Δ,k}(i,j)p(x−i,y−j)]+bₖ(x,y)−S(x,y))² (38)

where aₖ(x, y) and bₖ(x, y) are calculated with the ε value associated with Cₖ. How to determine the ε value for each Cₖ will be described below with respect to equations (44) and (45).

By making the partial derivative of SSEₖ with respect to h_{Δ,k}(i,j) equal to 0, one may obtain the modified Wiener-Hopt equation as in (39), of which the solution h_{Δ,k}(i,j) may be determined by ALF unit 28.

Σ_{i,j}h_{Δ,k}(i,j)(Σ_{x,y}aₖ²(x,y)p(x−i,y−j)p(x−m,y−n))=Σ_{x,y}aₖ(x,y)(S(x,y)−aₖ(x,Y)p′(x,y)−bₖ(x,y))p(x−m,y−n) (39)

The meaning of p′(x, y), as defined right below (10), is the result of filtering pixel p(x, y) by h_{pred,k}, and therefore aₖ(x, y)p′(x, y)+bₖ(x, y) is denoted as q′(x, y), meaning p′(x, y) filtered by GF. Then, (39) is re-written as (40).

Σ_{i,j}h_{Δ,k}(i,j)(Σ_{x,y}aₖ²(x,y)p(x−i,y−j)p(x−m,y−n))=Σ_{x,y}aₖ(x,y)(S(x,y)−q′(x,y))p(x−m,y−n) (40)

Comparing (40) with (12), where the solution h_{Δ,k} is optimized for the independent ALF, one may find the differences are (1) p′(x, y) is replaced by q′(x, y) and (2) weighting factors aₖ²(x, y) and aₖ(x, y) are multiplied on the left and right sides of the equation, respectively. Thus, R_{pp,k}(i−m,j−n) and R′_{ps,k}(m,n), first defined right above (13), are re-defined here as in (41) and (42), both of which are cumulated over all the (x, y) in Cₖ.

R_{pp,k}(i−m,j−n)=Σ_{x,y}aₖ²(x,y)p(x−i,y−j)p(x−m,y−n) (41)

R′_{ps,k}(m,n)=Σ_{x,y}aₖ(x,y)(x,y)−q′(x,y))p(x−m,y−n) (42)

R_{ss,k}, which is defined as the green term in (14), is also re-defined here as in (43), and cumulated over all the (x, y) in Cₖ.

R_{ss,k}=Σ_{x,y}(S(x,y)−q′(x,y)) (43)

It should be noted that the redefinitions of R_{pp,k}, R′_{ps,k}, and R_{ss,k} do not only effect the optimal filter derivation here, but also effect other parts of ALF optimization, such as the fast algorithm to find the lowest category merge cost, as described above with respect to pixel classification and filter derivation, and the fast algorithm to find the best quantized filter coefficients, as described above with respect to quantization of filter coefficients. Therefore, when ALF is optimized for GF, as is the ALF performed by ALF unit 28B, then R_{pp,k}, R′_{ps,k}, and R_{ss,k} used in equations (13) to (22) may all be cumulated by the new definitions as in (41), (42), and (43), respectively.

Video encoder 200 and video decoder 300 may be configured to determine an optimal ε value for each category and perform category merge. When calculating SSEₖ in equation (38), aₖ(x, y) and bₖ(x, y) are pre-calculated given εₖ, which may be one of the 24 values shown in Table 1. To find the optimal εₖ, full search is used here, which means SSEₖ with respect to all the different ε values are calculated, and only the ε value producing the smallest SSEₖ, denoted as ε_{opt,k}, is selected, as shown in (44).

$${ɛ}_{opt , k} = {arg min}_{ɛ} {SSE}_{k} {\vert}_{ɛ} \qquad ( 44 )$$

To speed up the calculations in full search, (14) is used, and therefore, R_{pp,k}, R′_{ps,k}, and R_{ss,k} with respect to all 24 ε values need to be cumulated and stored beforehand.

When merging two categories Cₙ and Cₘ, SSEₘ₊ₙ for the merged category is calculated, so that the SSE increase ΔSSEₘ₊ₙ, which is equal to SSEₘ₊ₙ−(SSEₘ+SSEₙ), can then be calculated and compared with that of other category merge options. Similarly, the optimal ε value for Cₘ₊ₙ, denoted as ε_{opt,m+n}, is expressed as in (45), and obtained by full search.

$${ɛ}_{opt , m + n} = {arg min}_{ɛ} {SSE}_{m + n} {\vert}_{ɛ} \qquad ( 45 )$$

In the full search, when certain ε value is being tried, (15) and (16) are used, in which R_{pp,k}, R′_{ps,k}, and R_{ss,k} are all with respect to that ε value.

After Cₙ and Cₘ are determined to be merged, R_{pp,k}, R′_{ps,k}, and R_{ss,k} are also updated in the similar way as in (17) to (19). But note that R_{pp,k}, R′_{ps,k}, and R_{ss,k} with respect to all the possible ε values (not only with respect to ε_{opt,m+n}) need to be updated, so that they can be used in future category merge.

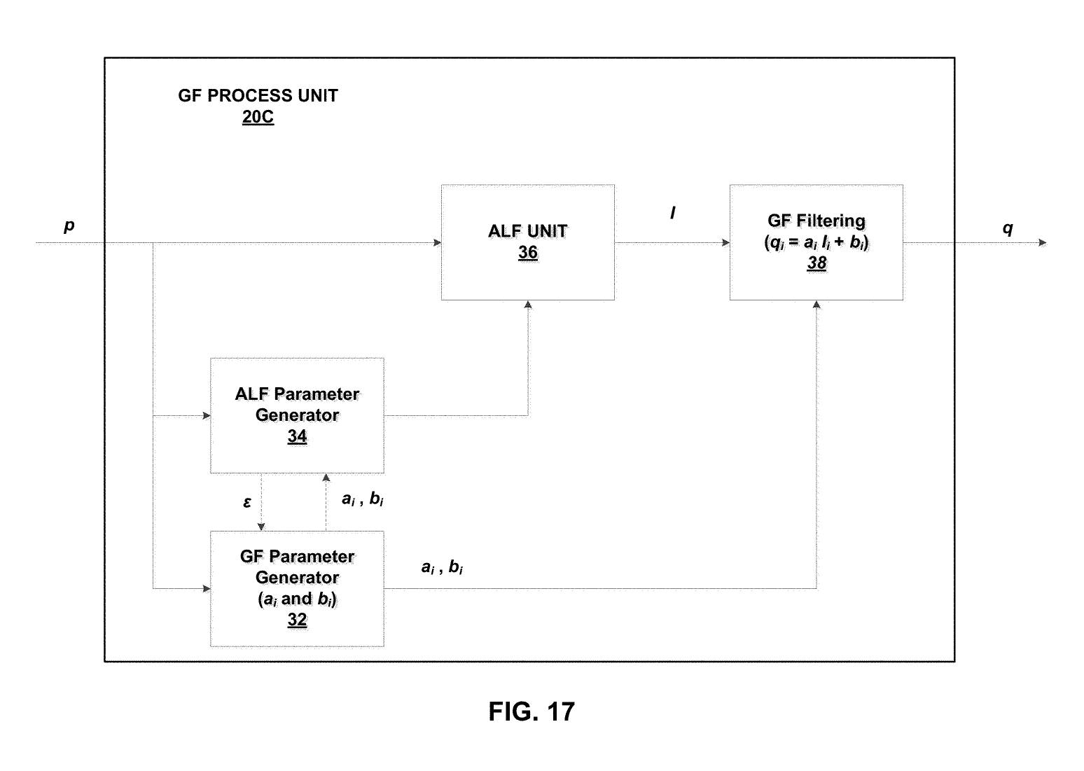

When implementing the techniques of this disclosure, video encoder 200 and video decoder 300 may be configured to implement multiple in-loop filters concatenated with short latency. The example of GF process unit 20B, which used ALF unit 28B as an “I Generator” has been introduced in detail, ALF unit 28B being a component within GF process unit 20B. However, the system can also be designed in another way, where ALF and GF are concatenated (see FIG. 17).

FIG. 17 shows another example implementation of filter unit 312, in which GF and ALF are concatenated. In the example of FIG. 17, GF process unit 20C includes GF parameter generation unit 32, ALF parameter generation unit 34, ALF unit 36, and GF filtering unit 38. GF process unit 20C of FIG. 17 may, for example, be configured to receive a reconstructed image (p) as an input. Based on the reconstructed image, ALF parameter generation unit 34 may determine ALF parameters, and GF parameter generation unit 32 may determine GF parameters (e.g., aᵢ and bᵢ described above). ALF unit 36 filters the reconstructed image, using the ALF parameters, to determine a guidance image (I). GF filtering unit filters the guidance image, using the GF parameters, to determine a filtered image (q).

In FIG. 17, both ALF and GF include two separate units, i.e., parameter generating units and filtering units. For the decoder-side ALF, the parameter generator generates the pixel classification related information. For the encoder-side ALF, the parameter generator needs to generate more information, such as filter coefficients, number of filter taps, filter predictions, and block-based on/off information described above with respect to ALF. All the necessary information is fed into the filtering units, where only the FIR filtering is performed, such as (23), (35), and any other variants. GF parameter generation unit 32 and GF filtering unit may collectively perform the same functionality as ai and bi generator 22B and qi determination unit 26 of FIG. 16, and ALF parameter generation unit 34 and ALF unit 36 may collectively perform the same functionality as ALF unit 28B in FIG. 16.

The information of ALF parameter generator and GF parameter generator may be shared. On the decoder side, parameter c used in GF parameter generator is determined based on the pixel classification information from ALF parameter generator. On the encoder side, the information of the two parameter generators is shared even more, because of the joint optimization of ALF and GF as described above, with respect to Encoder-Side Optimization.

As discussed above, the main computational burden is in the parameter generators. Comparatively, the processing in the filtering units is relatively simple and fast. In the example of FIG. 17, the parameter generators, which are computationally heavy, are parallel, whereas the lightweight filtering units are serial. By doing this, the encoding and decoding latency is significantly reduced compared with the completely concatenated in-loop filters shown in FIGS. 10A-10E, although the pipeline is still the same length.

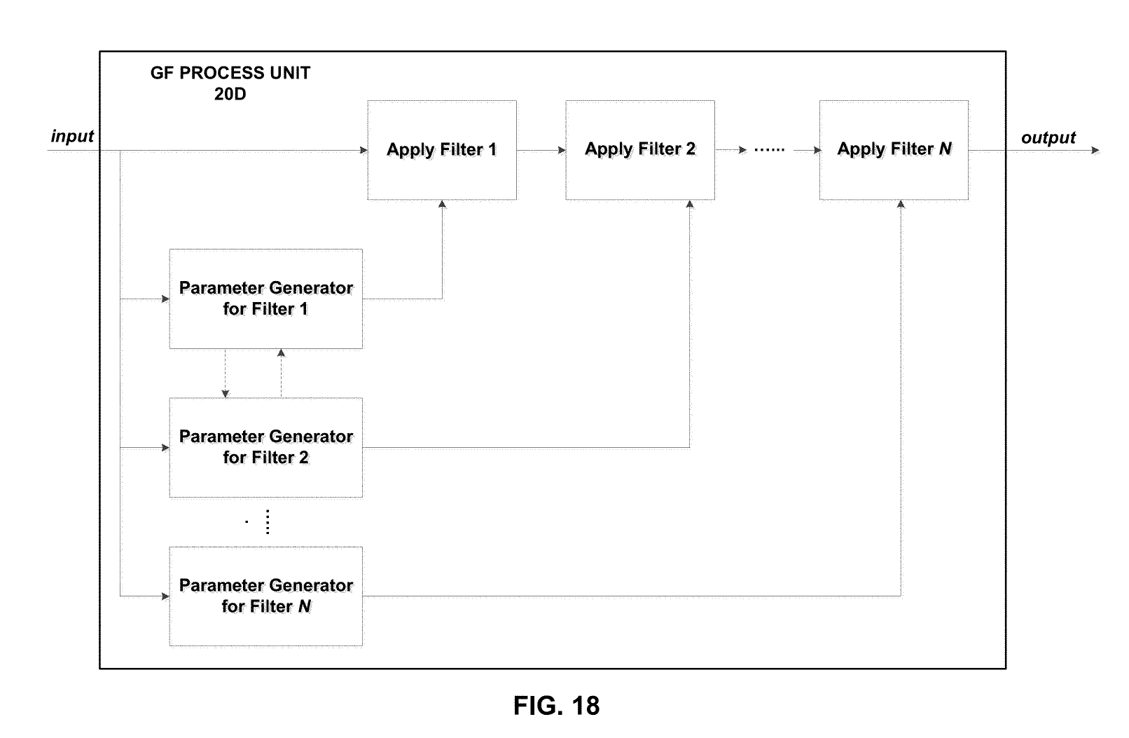

FIG. 18 shows example implementation of GF process unit 20D, in which N in-loop filters are concatenated with short latency. When multiple filters are concatenated for in-loop filtering, as in FIG. 18, the two functions of each filter, parameter generating and filtering using the generated parameters, can be separated (the separation can be virtual). The parameter generators may operate in parallel, and the filtering stages operate serially. The parameter generators may share each other's information. GF process unit 20D may, for example, be configured to receive a reconstructed image as an input and apply a first filter to the reconstructed image to determine a first filtered image. Based on the reconstructed image, GF process unit 20D determines parameters for a second filter. GF process unit 20D applies the second filter, using the parameters for the second filter, to the first filtered image to determine a second filtered image. In some examples, GF process unit 20D may be configured to apply more than two filters. For example, GF process unit 20D may based on the reconstructed image, determine parameters for a third filter and apply the third filter, using the parameters for the third filter, to the second filtered image to determine a third filtered image.

FIG. 19 is a block diagram illustrating an example video encoder 200 that may perform the techniques of this disclosure. FIG. 19 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266 video coding standard in development. However, the techniques of this disclosure are not limited to these video coding standards, and are applicable generally to video encoding and decoding.

In the example of FIG. 19, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 19 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit does not further partition a CU into PUs, each CU may be associated with a luma coding block and corresponding chroma coding blocks. As above, the size of a CU may refer to the size of the luma coding block of the CU. Video encoder 200 and video decoder 300 may support CU sizes of 2N×2N, 2N×N, or N×2N.

For other video coding techniques such as an intra-block copy mode coding, an affine-mode coding, and linear model (LM) mode coding, as few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

FIG. 20 is a block diagram illustrating an example video decoder 300 that may perform the techniques of this disclosure. FIG. 20 is provided for purposes of explanation and is not limiting on the techniques as broadly exemplified and described in this disclosure. For purposes of explanation, this disclosure describes video decoder 300 is described according to the techniques of JEM and HEVC. However, the techniques of this disclosure may be performed by video coding devices that are configured to other video coding standards.

In the example of FIG. 20, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Prediction processing unit 304 includes motion compensation unit 316 and intra-prediction unit 318. Prediction processing unit 304 may include addition units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to executed by processing circuitry of video decoder 300.

The various units shown in FIG. 20 are illustrated to assist with understanding the operations performed by video decoder 300. The units may be implemented as fixed-function circuits, programmable circuits, or a combination thereof. Similar to FIG. 19, fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 19).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 19). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 1.

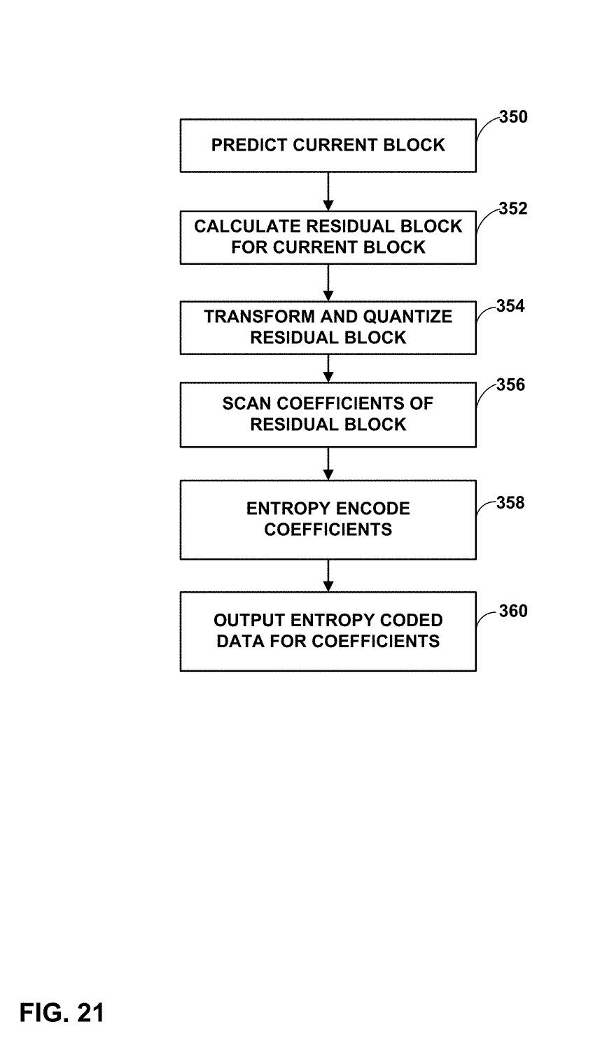

FIG. 21 is a flowchart illustrating an example operation of a video encoder for encoding a current block of video data. The current block may include a current CU. Although described with respect to video encoder 200 (FIGS. 1 and 2), it should be understood that other devices may be configured to perform an operation similar to that of FIG. 21.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, uncoded block and the prediction block for the current block. Video encoder 200 may then transform and quantize coefficients of the residual block (354). Next, video encoder 200 may scan the quantized transform coefficients of the residual block (356). During the scan, or following the scan, video encoder 200 may entropy encode the coefficients (358). For example, video encoder 200 may encode the coefficients using CAVLC or CABAC. Video encoder 200 may then output the entropy coded data of the block (360).

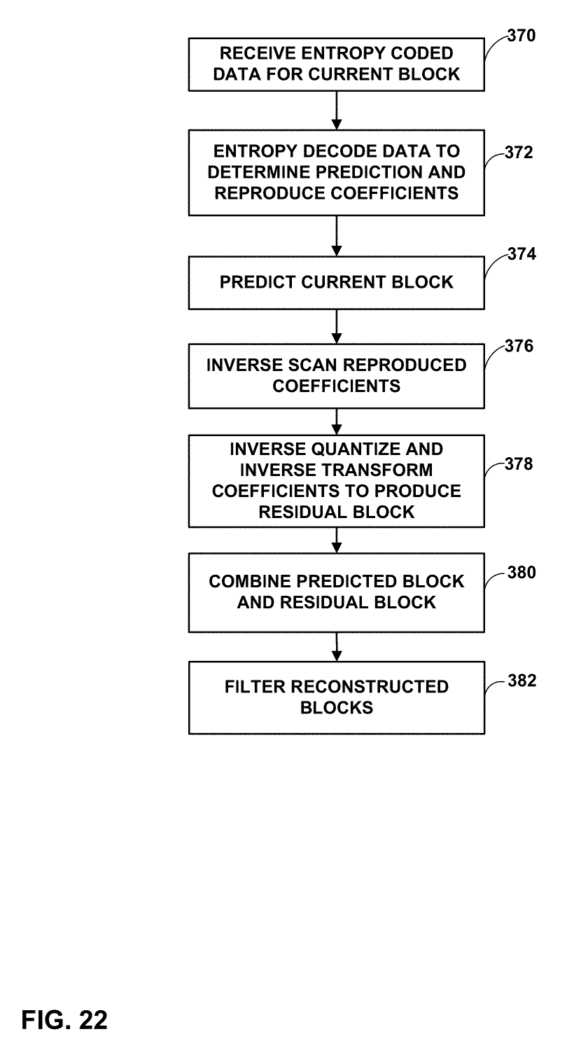

FIG. 22 is a flowchart illustrating an example operation of a video decoder for decoding a current block of video data. The current block may include a current CU. Although described with respect to video decoder 300 (FIGS. 1 and 3), it should be understood that other devices may be configured to perform an operation similar to that of FIG. 22.

Video decoder 300 may receive entropy coded data for the current block, such as entropy coded prediction information and entropy coded data for coefficients of a residual block corresponding to the current block (370). Video decoder 300 may entropy decode the entropy coded data to determine prediction information for the current block and to reproduce coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced coefficients (376), to create a block of quantized transform coefficients. Video decoder 300 may then inverse quantize and inverse transform the coefficients to produce a residual block (378). Video decoder 300 may ultimately decode the current block by combining the prediction block and the residual block (380). After combining the prediction block and the residual block to generate a reconstructed block, video decoder 300 may apply one or more filters (e.g., deblocking, SAO, and/or ALF/GALF) to the unfiltered reconstructed block to generate a filtered reconstructed block (382).

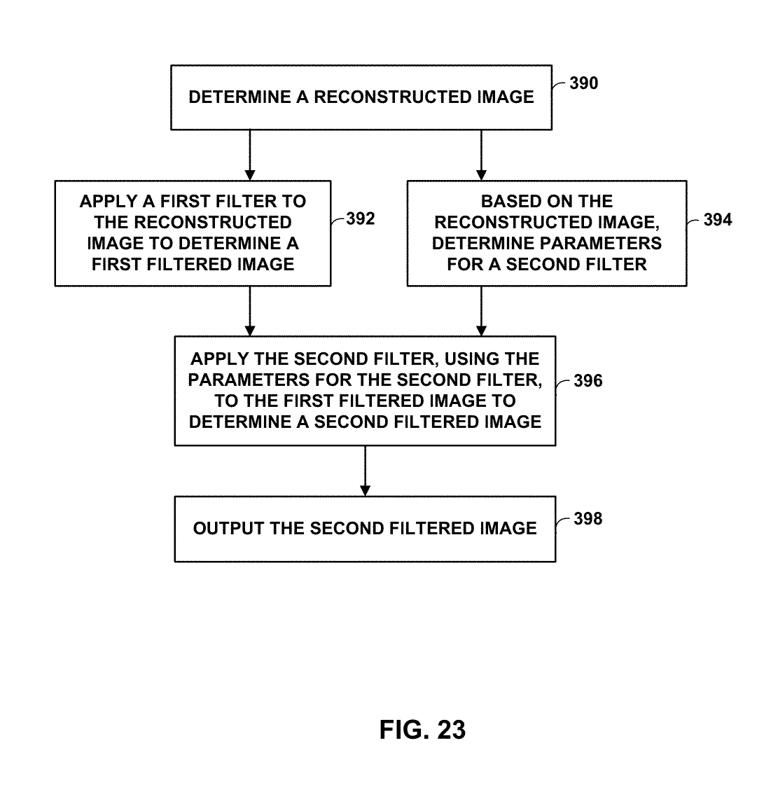

FIG. 23 is a flowchart illustrating an example video decoding technique described in this disclosure. The techniques of FIG. 23 will be described with reference to a generic video decoder, such as but not limited to video decoder 300 (e.g., filter unit 312). In some instances, the techniques of FIG. 23 may be performed by the decoding loop of video encoder 200 (e.g., filter unit 216).

In the example of FIG. 23, the video decoder determines a reconstructed image (390). In some examples, the reconstructed image may, for example, be the output of reconstruction unit 310 or 214. In other examples, the reconstructed image may have undergone some type of filtering, such as deblock filtering. The video decoder applies a first filter to the reconstructed image to determine a first filtered image (392). In some examples the video decoder applies the first filter to the reconstructed image to determine a guidance image. The first filter may, for example, be ALF. Based on the reconstructed image, the video decoder determines parameters for a second filter (394). The video decoder may, for example, determine the parameters for the second filter by determining a first parameter (e.g., a, described above) and a second parameter (e.g., bi described above) based on the reconstructed image.

The video decoder applies the second filter, using the parameters for the second filter, to the first filtered image to determine a second filtered image (396). The video decoder may, for example, apply the second filter, using the parameters for the second filter, to the first filtered image to determine the second filtered image by modifying the guidance image based on the first parameter and the second parameter to determine the second filtered image.

The video decoder outputs the second filtered image (398). The video decoder may, for example, output the second filtered image to a memory for storage as a reference image or for future display, output the second filtered image to a display device, or output the seconded filtered image to other components of the video decoder for additional processing, such as additional filtering.

FIG. 23 shows steps 392 and 394 as being performed in parallel, but in some implementations, theses steps may be performed sequentially or partially in parallel, as explained elsewhere in this disclosure.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining a reconstructed image;
applying a first filter to the reconstructed image to determine a first filtered image;
based on the reconstructed image, determining parameters for a second filter;
applying the second filter, using the parameters for the second filter, to the first filtered image to determine a second filtered image.

2. The method of claim 1, further comprising:
based on the reconstructed image, determining parameters for a third filter;
applying the third filter, using the parameters for the third filter, to the second filtered image to determine a third filtered image.

3. The method of claim 1, wherein applying the first filter to the reconstructed image comprises performing filtering on the reconstructed image to determine a guidance image;
wherein determining the parameters for the second filter comprises determining a first parameter and a second parameter based on the reconstructed image; and
wherein applying the second filter, using the parameters for the second filter, to the first filtered image to determine the second filtered image comprises modifying the guidance image based on the first parameter and the second parameter to determine the second filtered image.

4. The method of claim 3, wherein performing filtering on the reconstructed image to determine the guidance image comprises performing adaptive loop filtering on the reconstructed image.

5. The method of claim 1, wherein the reconstructed image comprises a deblocked, reconstructed image.

6. The method of claim 1, further comprising:
storing the second filtered image as a reference picture.

7. The method of claim 1, wherein the method is performed as part of a video encoding operation.

8. A device for decoding video data, the device comprising:
a memory configured to store the video data; and
one or more processors coupled to the memory, implemented in circuitry, and configured to:
determine a reconstructed image;
apply a first filter to the reconstructed image to determine a first filtered image;
based on the reconstructed image, determine parameters for a second filter; and
apply the second filter, using the parameters for the second filter, to the first filtered image to determine a second filtered image.

9. The device of claim 8, wherein the one or more processors are further configured to:
based on the reconstructed image, determine parameters for a third filter;
apply the third filter, using the parameters for the third filter, to the second filtered image to determine a third filtered image.

10. The device of claim 8,
wherein to apply the first filter to the reconstructed image, the one or more processors are further configured to perform filtering on the reconstructed image to determine a guidance image;
wherein to determine the parameters for the second filter, the one or more processors are further configured to determine a first parameter and a second parameter based on the reconstructed image; and
wherein to apply the second filter, using the parameters for the second filter, to the first filtered image to determine the second filtered image, the one or more processors are further configured to modify the guidance image based on the first parameter and the second parameter to determine the second filtered image.

11. The device of claim 10, wherein to perform filtering on the reconstructed image to determine the guidance image, the one or more processors are further configured to perform adaptive loop filtering on the reconstructed image.

12. The device of claim 8, wherein the reconstructed image comprises a deblocked, reconstructed image.

13. The device of claim 8, wherein the one or more processors are further configured to:
store the second filtered image as a reference picture.

14. The device of claim 8, wherein the device comprises a wireless communication device, further comprising a transmitter configured to transmit encoded video data.

15. The device of claim 14, wherein the wireless communication device comprises a telephone handset and wherein the transmitter is configured to modulate, according to a wireless communication standard, a signal comprising the encoded video data.

16. The device of claim 8, wherein the device comprises a wireless communication device, further comprising a receiver configured to receive encoded video data.

17. The device of claim 16, wherein the wireless communication device comprises a telephone handset and wherein the receiver is configured to demodulate, according to a wireless communication standard, a signal comprising the encoded video data.

18. A computer readable storage medium storing instructions that when executed by one or more processors cause the one or more processors to:
determine a reconstructed image;
apply a first filter to the reconstructed image to determine a first filtered image;
based on the reconstructed image, determine parameters for a second filter;
apply the second filter, using the parameters for the second filter, to the first filtered image to determine a second filtered image.

19. The computer readable storage medium of claim 18, storing further instructions that cause the one or more processors to:
based on the reconstructed image, determine parameters for a third filter;
apply the third filter, using the parameters for the third filter, to the second filtered image to determine a third filtered image.

20. The computer readable storage medium of claim 18,
wherein to apply the first filter to the reconstructed image, the instructions cause the one or more processors to perform filtering on the reconstructed image to determine a guidance image;
wherein to determine the parameters for the second filter, the instructions cause the one or more processors to determine a first parameter and a second parameter based on the reconstructed image; and
wherein to apply the second filter, using the parameters for the second filter, to the first filtered image to determine the second filtered image, the instructions cause the one or more processors to modify the guidance image based on the first parameter and the second parameter to determine the second filtered image.

21. The computer readable storage medium of claim 20, wherein to perform filtering on the reconstructed image to determine the guidance image, the instructions cause the one or more processors to perform adaptive loop filtering on the reconstructed image.

22. The computer readable storage medium of claim 18, wherein the reconstructed image comprises a deblocked, reconstructed image.

23. The computer readable storage medium of claim 18, storing further instructions that cause the one or more processors to:
store the second filtered image as a reference picture in a memory.

24. The computer readable storage medium of claim 18, storing further instructions that cause the one or more processors to encode the video data.

25. An apparatus for decoding video data, the apparatus comprising:
means for determining a reconstructed image;
means for applying a first filter to the reconstructed image to determine a first filtered image;
means for determining parameters for a second filter based on the reconstructed image;
means for applying the second filter, using the parameters for the second filter, to the first filtered image to determine a second filtered image.

26. The apparatus of claim 25, further comprising:
means for determining parameters for a third filter based on the reconstructed image;
means for applying the third filter, using the parameters for the third filter, to the second filtered image to determine a third filtered image.

27. The apparatus of claim 25,
wherein the means for applying the first filter to the reconstructed image comprises apparatus performing filtering on the reconstructed image to determine a guidance image;
wherein the means for determining the parameters for the second filter comprises apparatus determining a first parameter and a second parameter based on the reconstructed image; and
wherein means for applying the second filter, using the parameters for the second filter, to the first filtered image to determine the second filtered image comprises apparatus modifying the guidance image based on the first parameter and the second parameter to determine the second filtered image.

28. The apparatus of claim 27, wherein the means for performing filtering on the reconstructed image to determine the guidance image comprises means for performing adaptive loop filtering on the reconstructed image.

29. The apparatus of claim 25, wherein the reconstructed image comprises a deblocked, reconstructed image.

30. The apparatus of claim 25, further comprising:
means for storing the second filtered image as a reference picture.
